(19) United States
(12) Patent Application Publication
(10) Pub. No.: US 2006/0036026 A1
(43) Pub. Date: Feb. 16, 2006

(54) Resin composition and manufacturing method therefor

(75) Inventor: Katsuhisa Masumoto, Hirakata-shi (JP)

Correspondence Address: PITNEY HARDIN LLP, 7 TIMES SQUARE, NEW YORK, NY, 10036-7311, US

(73) Assignee: White Max Co., Ltd.

(21) Appl. No.: 11/153,566

(22) Filed: Jun. 14, 2005

Related U.S. Application Data
(63) Continuation-in-part of application No. 10/411,681, filed on Apr. 11, 2003, now abandoned.
Application No. 10/411,681 is a continuation of application No. 09/759,942, filed on Jan. 11, 2001, now Pat. No. 6,562,898.

(30) Foreign Application Priority Data
Jul. 5, 2000 (JP) JP2000/204204

(51) Int. Cl. C08G 18/67

(52) U.S. Cl. 524/580; 524/612; 427/2.24; 427/2.25

(57) ABSTRACT

The present invention relates to resin composition with superior antioxidant properties, mechanical strength and insulating properties. A mixture of a thermoplastic resin in pellet or granular form and water is heated under pressure at a subcritical condition of the water to melt the thermoplastic resin, and the melted resin is cooled.

### CROSS REFERENCE TO RELATED APPLICATION

This application is a continuation-in-part (CIP) of U.S. patent application Ser. No. 10/411,681, filed Apr. 11, 2003, which is a continuation of U.S. patent application Ser. No. 09/759,942, filed Jan. 11, 2001, now U.S. Pat. No. 6,562,898.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The present invention relates to a resin composition with superior antioxidant properties, as well as mechanical strength and insulating properties.

The present inventors proposed a certain type of resin composition in Japanese Unexamined Patent Application Disclosure (Kokai) No. 10-87840. There, a thermoplastic resin was wetted in water with an oxidation-reduction potential of between −420 mV and 200 mV and the wet thermoplastic resin was melted under heat and pressure to form an antioxidizing resin. The thermoplastic resin was melted at a temperature between 170° C. and 250° C. under pressure ranging between 5 and 30 MPa. Low molecular antioxidant substances produced by a group of effective microorganisms were mixed in with the −420 mV to 200 mV water.

This antioxidizing resin is ideal in film for wrapping food products and containers for storing food products because of the good oxidation-inhibiting effect of the resin on vegetables, fruits, grains, meats and fish. However, when this resin was used for large containers, such as containers used for transporting food products or tanks for storing drinking water, the resin maintained its superior antioxidizing properties but did not exhibit sufficient mechanical strength for manufacturing large containers.

### SUMMARY

An object of the present invention is to obtain a resin composition with superior antioxidant properties, mechanical strength and insulating properties.

According to one embodiment of the present invention, the thermoplastic resin of the present invention is formed by melting a mixture of a thermoplastic resin in pellet or granular form and purified water or distilled water with the impurities removed. The melting is performed by using heat and pressure under a subcritical condition of water. The melted resin is then cooled by, for example, using cold water with the impurities removed.

According to another embodiment of the present invention, the thermoplastic resin of the present invention is formed by melting a mixture of a thermoplastic resin in pellet or granular form and natural unchanged water. The melting is performed by using heat and pressure under a subcritical condition of water. The melted resin is then cooled by, for example, using cold water with the impurities removed.

According to a further embodiment of the present invention, the thermoplastic resin of the present invention is formed by melting a mixture of a thermoplastic resin in pellet or granular form and purified water or distilled water containing antioxidizing substances produced by groups of effective microorganisms. The melting is performed by using heat and pressure under a subcritical condition of water. The melted resin is then cooled by, for example, using cold water with the impurities removed.

Preferably, the thermoplastic resin is polyethylene or polypropylene; however, the present invention is not restricted to these two types of resin.

One method for manufacturing a resin composition of the present invention comprises a first stage wherein a thermoplastic resin in pellet or granular form is mixed and stirred in purified water or distilled water with the impurities removed; a second stage wherein the mixture is heated and pressurized under a subcritical condition of water and the thermoplastic resin is melted; and a third stage wherein the melted resin obtained in the second stage is cooled using cold water with the impurities removed.

Alternatively, in the first stage, the thermoplastic resin in pellet or granular form may be mixed and stirred in natural unchanged water, or in purified water, or distilled water containing antioxidizing substances produced by groups of effective microorganisms.

The purified water with impurities removed refers to tap water filtered using ceramics, activated charcoal or any other means known in the art to remove impurities such as chlorine. The distilled water refers to tap water distilled to remove impurities such as chlorine. The natural unchanged water refers to water containing minerals such as, for example, deep ocean water, mineral water and anionic mineral water. The purified or distilled water containing antioxidizing substances produced by groups of effective microorganisms refers to purified water or distilled water containing a small amount of antioxidizing substances. Preferably, it is a mix of a small amount of antioxidizing substances produced by groups of effective microorganisms (1 to 5 ppw antioxidizing substances per 100 ppw purified water) and tap water dechlorinated using ceramics.

Preferably, the thermoplastic resin raw material is polyolefin resin such as, for example, polyethylene or polypropylene. However, the present invention is not restricted to these two types of resin. Other examples include polystyrene (PS), AS resin, ABS resin, methacrylic resin (PMMA), polyamide (PA), polycarbonate (PC), polyethylene terephthalate (PET), polybutylene terephthalate (PBT), ionomer (IO), polyvinyl butyral (PVB), polyvinyl alcohol (PVA), polyacetal (POM), polyphenylene oxide (PPO), polyphenylene sulfide (PPS), polyether ether ketone (PEEK), fluorine-based resins (PFA, ETFE, etc.), polyimide (PI), polyarylate (PAR), polysulfone (PSU), polyether sulfone (PES), polyether imide (PEI), polyimide (PAI), polyurethane (PU) and cellulose-based resins such as acetyl cellulose and cellulose acetate butylate.

The resin pellets are melted by heat and pressure under a subcritical condition of water. Subcritical conditions of water refers to a state below the critical point of water (374° C. and 22 MPa). The melting conditions depend on the type of thermoplastic resin, but in general, when an extruder is used, the thermoplastic resins may be melted under a pressure range of between 10 and 22 MPa (preferably between 15 and 22 MPa) and at a temperature range of between 150 and 370° C. (preferably between 200 and 250° C.).

Groups of effective microorganisms that produce antioxidizing substances are generally a group of more than 80 species of microorganism in 10 genuses of different functions, which are known as “effective microorganisms (EM)”. The principal types of bacteria are photosynthetic bacteria, lactic acid bacteria, yeasts and mycobacteria. (See Akio Hiyoshi, “The EM Encyclopedia: How the EM Environmental Revolution Will Change Human Life”, Sogo Unicom Co., Ltd., No. 282, p. 283.) The low molecular antioxidizing substances produced by EM are known as “EM-X”. The EM-X are manufactured by fermenting plant material or seaweed using EM, removing the oxides using ozone, and removing the residues and microorganisms using various filters. EM-X comprises many different kinds of plant-derived or microorganism-derived antioxidizing substances.

The preferred ratio of mixing the thermoplastic resin in pellet or grain form (hereinafter referred to as resin pellets) and water is 1 to 5 ppw water per 100 ppw resin pellets. If less than 1 ppw or more than 5 ppw water is added, a resin composition with superior antioxidizing properties cannot be obtained.

It is clear from the physical property testing to be explained below that the resin compositions of the present invention have superior mechanical strength and insulating properties, and it is clear from the test data in the embodiment to be described below that the resin compositions of the present invention prevent oxidation. It is believed that melting the resin pellets at a subcritical condition of water improves the hydrophobic properties of the resin compositions (Physical Property Test No. 2), but the theoretical mechanism is not understood.

The present inventors were able to verify that the physical properties of the resin compositions in the present invention were not changed by the heat and pressure that are present during usual product molding processes. In other words, the physical properties of the resin compositions in the present invention were not changed when the pellets were molded (e.g., propylene melted at 200° C.) and processed into containers or wrapping for food products.

Therefore, using the resin compositions of the present invention as molding material for containers and sheets prevents putrefaction or denaturing of the contents of the containers and allows the container to withstand heavy loads. For example, containers molded from the resin compositions of the present invention preserve fresh foods much longer than containers made from conventional resin compositions. Also, large containers for transporting foods and tanks for drinking water could also be molded using the resin compositions of the present invention, unlike the previous resin compositions. The resin composition of the present invention also can be used as a liner of a refrigerator, so that the refrigerator has a superior ability to keep fresh foods from spoiling. Because of improved mechanical strength, the resin compositions of the present invention can be used in situations requiring long-term use, such as liners for pipes. Because of improved electrical resistance and insulation breakdown strength, the resin compositions of the present invention also can be used to coat electric wires. If the resin compositions are made using non-chlorine resins such as polyethylene and polypropylene, development of dioxins can be prevented at the time of waste disposal.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a diagram of the manufacturing stages for the resin composition of the present invention;

FIG. 2 is an infrared absorption spectrum for EMB;

FIG. 3 is an infrared absorption spectrum for PP;

FIG. 4 is a diagram used to explain the mechanical strength testing method;

FIG. 5 is a graph of the results from the mechanical strength test performed on EMB and PP;

FIG. 6 is a diagram used to explain the electrical resistance testing method;

FIG. 7 is a diagram used to explain the insulation breakdown testing method; and

FIG. 8 is a graph showing the change over time in the chlorine ion concentration of the aqueous solution.

### DETAILED DESCRIPTION OF THE PREFERRED EMBODIMENTS

### EXAMPLE 1

### A Method for Manufacturing Thermoplastic Resin

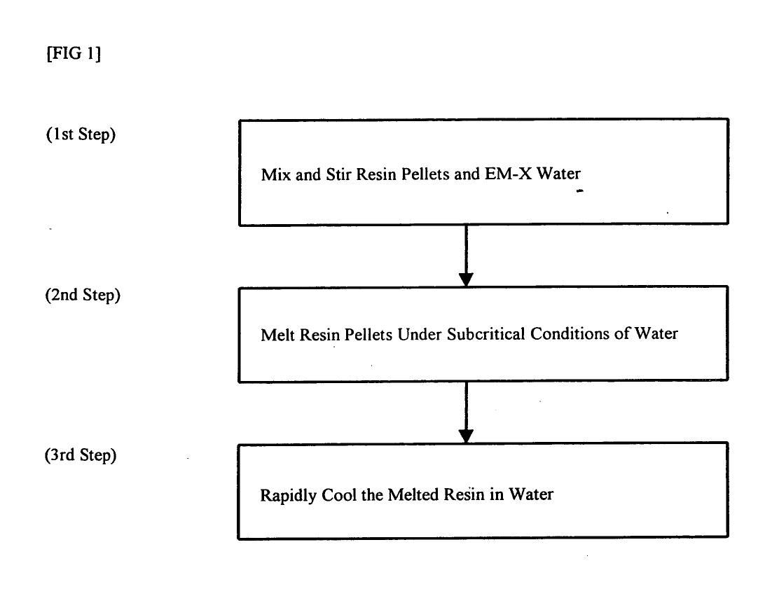

As shown in FIG. 1, there are three stages in the manufacturing process for the resin compositions of the present invention. In the preferred embodiment, mono-axial extruder (Monoaxial 65-36V manufactured by Osaka Precision Equipment Co., Ltd.) was used in the manufacturing process. In Stage 1, polyethylene resin pellets (specific gravity 0.91 to 0.93), which are raw material, are mixed with EM-X water in a hopper of the extruder and stirred for 20 to 30 minutes. Preferably, the compositional ratio is 1 kg of EM-X water per 100 kg of resin pellets. Preferably, the EM-X water is a trace amount of EM-X mixed into tap water dechlorinated using ceramics.

In Stage 2, the mixture of polyethylene resin pellets and EM-X water is added to a cylinder and said resin pellets are heated and melted inside the cylinder at a temperature between 200 and 250° C. Also, the extrusion speed is adjusted under said temperature conditions so that the pressure inside the cylinder is between 10 and 22 MPa. The pressure and temperature conditions inside the cylinder satisfy a subcritical condition of water.

In Stage 3, the melted resin obtained in Stage 2 is rapidly cooled in cold water with the impurities removed. At this time, the melted resin is rapidly cooled while being stretched into the shape of vermicelli. The hardened vermicelli-shaped resin is then cut into chips. These chips are the resin composition of the present invention. The extrusion speed (discharge rate) is 60 to 140 kg/hr, the extrusion pressure (rotational) is 200 to 250 rpm, and the length of the cooling layer is 3 to 4 m. The resin composition is chip-shaped because it is easier to use when molding into films or containers. Thus, the resin composition does not have to be chip-shaped. Water with impurities removed, distilled water or natural unchanged water may be used instead of the EM-X water. Whether the raw material is polypropylene pellets or pellets of some other thermoplastic resin, the thermoplastic resin composition of the present invention can be obtained using the same method.

### EXAMPLE 2

### Physical Properties of a Resin Composition of the Present Invention

The following tests were conducted on a resin composition of the present invention (EMB) and a commercially available polypropylene synthetic resin (PP) to study the differences in their physical properties. In Test Nos. 1 through 10, EMB was in the form of a plate or sheet produced using a molding device by heating and melting (at 200° C.) the pellets of thermoplastic resin composition (propylene) obtained in said process using EM-X water. PP was in the form of a plate or sheet produced using a molding device by heating and melting (at 200° C.) ordinary polypropylene resin pellets. Therefore, the exact same manufacturing process was performed on the PP so that the only difference between the PP and the EMB was the resin composition. Also, a water quality test, Test No. 11, was conducted on a water tank made from EMB (polyethylene) and a water tank made from ordinary polypropylene PP.

The eleven tests conducted were as follows:
1. Visual Inspection
2. Electron Microscope Observation (SEM Photography)
3. Melting Point Measurement
4. Contact Angle Measurement
5. Infrared Absorption Spectrum
6. Ultraviolet Absorption Spectrum
7. Mechanical Strength Test
8. Density Measurement
9. Electrical Resistance Measurement
10. Insulation Strength Measurement
11. Measurement of Water Quality in Tank
   1. Visual Inspection

When the surface was inspected with a naked eye, the EMB was transparent without any cloudiness whereas the PP was somewhat whitish. In the cutting test using scissors, the EMB was difficult to cut whereas the PP was easy to cut.

2. Electron Microscope Observation (SEM Photography)

The surface and cross-section of both samples were compared under a scanning electron microscope (NEC JSM-5410) at magnification factors between 35× and 3500×. No significant differences were detected. In the photographs of the surfaces of the samples taken at a magnification factor of 3500×, it is suspected that the EMB is a little finer.

3. Melting Point Measurement

In the melting point measurement, grains of EMB and PP were placed in test tubes. The test tubes were then placed in an oil bath. The EMB grains were cylindrical whereas the PP grains were bun-shaped. The melting point of the EMB was 148.5° C. with a rising rate of 0.5° C./mm. The melting point of the PP was 165° C. with a rising rate of 0.3° C./min.

4. Contact Angle Measurement

The contact angle θ of purified water added dropwise to the surface of the EMB and PP was measured using a contact-angle meter manufactured by Kyowa Kaimen Kagaku Co., Ltd. The results are shown in Table 1.

TABLE 1

| PP (θ/2) | AVERAGE | θ | EMB (θ/2) | AVERAGE | θ |
|---|---|---|---|---|---|
| 38.0 | 37.6 | 75.2 | 44.9 | 45.1 | 89.8 |
| 37.4 | | | 44.9 | | |
| 37.3 | | | 45.5 | | |

The contact angle measurements for water were different. The cause is not understood, but it is verified that the EMB is clearly more hydrophobic than the PP. This difference is believed to have an effect on preventing water from traveling to the surface of the resin from a food product when fresh food is stored in a container made from the resin. It is also believed to have an effect on preventing putrefaction.

5. Ultraviolet Absorption Spectrum (UV Measurement)

The UV absorption spectrum wavelengths for EMB and PP film were measured using an ultraviolet absorption spectrum measuring device (UV-2100 manufactured by Shimazu Co., Ltd.). The results are shown in Table 2. A significant difference was not discovered.

TABLE 2
EMB

| | WAVELENGTH (nm) | VALUE (A) (Δ) |
|---|---|---|
| [[PEAK DATA]] | | |
| No. | | |
| 1 | 271.5 | 1570 (0.293) |
| 2 | 219.5 | 3.655 (1.014) |
| [[VALLEY DATA]] | | |
| No. | | |
| 1 | 251.0 | 1.334 (−1.126) |
| PP | | |
| [[PEAK DATA]] | | |
| No. | | |
| 1 | 273.0 | 2.193 (0.122) |
| 2 | 225.0 | 3.991 (1.298) |
| [[VALLEY DATA]] | | |
| No. | | |
| 1 | 249.5 | 1.595 (−1.455) |

6. Infrared Absorption Spectrum (FTIR)

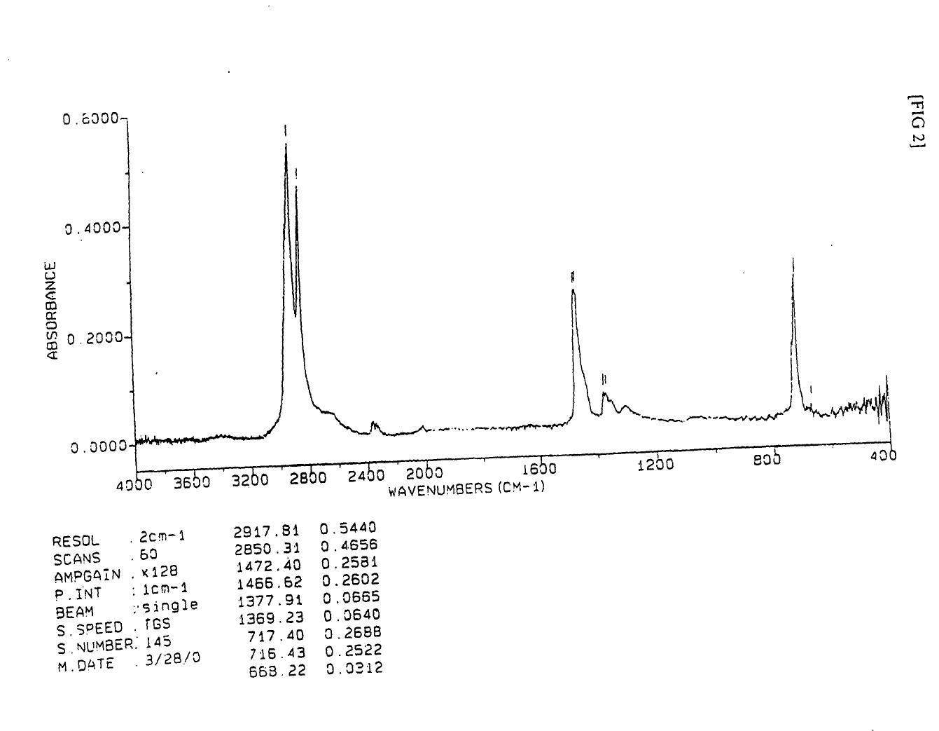

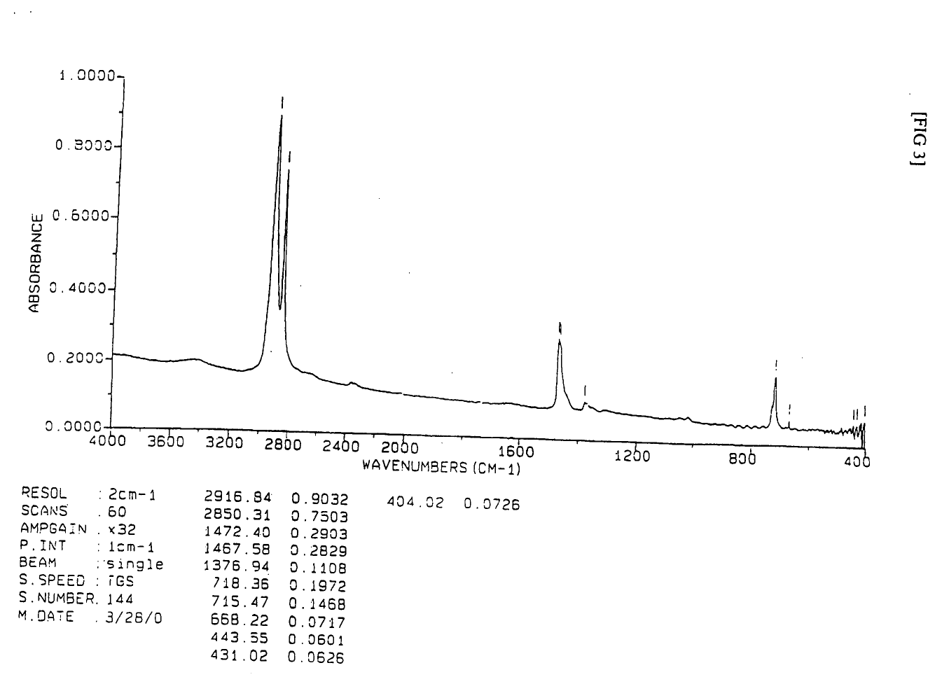

A qualitative and quantitative analysis was performed on the EMB and the PP using a fourier transform infrared spectrophotometer (JIR-7000 manufactured by NEC Corporation). The samples were granular. (The EMB grains were cylindrical with a diameter of 2.4 mm, a height of 3.5 mm, and a thickness of 3.6 mm. The PP grains were tablets with a long diameter of 4.2 mm and a short diameter of 3.8 mm.) The results are shown in FIGS. 2 and 3.

Both plastics had peaks at the same wavelengths as shown in FIGS. 2 and 3. This means that both plastics have the same constituents. However, all of the infrared absorption peaks were shorter in the EMB (FIG. 2) than in the PP (FIG. 3). It is believed that the EMB has a longer distance between oscillating atoms and a smaller partial load.

7. Mechanical Strength Test

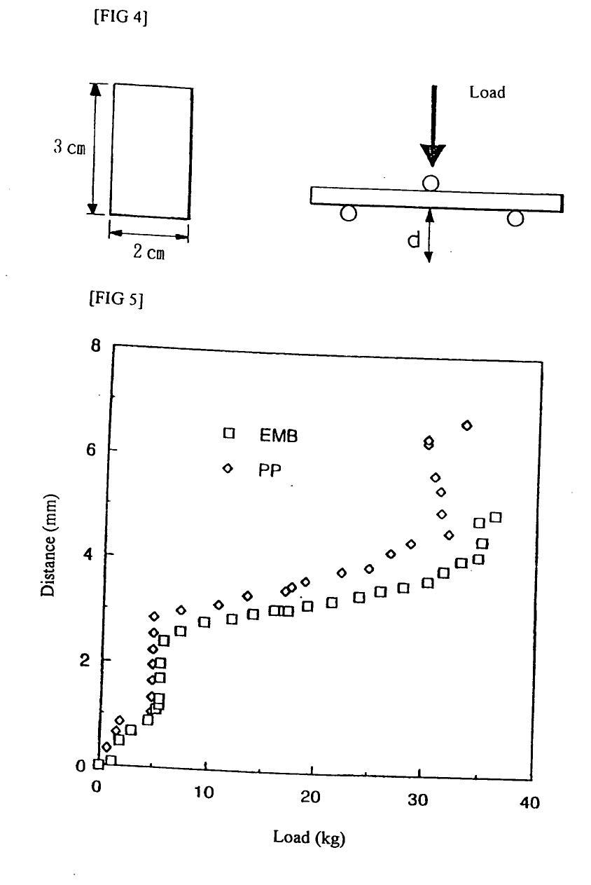

As shown in FIG. 4, samples of the EMB and PP were prepared with a width of 2 cm, a length of 3 cm, and a thickness of 2 mm. The samples were supported at two points and a load was applied to the center. The flexural distance (d) was used to evaluate the mechanical strength of the EMB and the PP. The results are shown in Table 5.

As shown in FIG. 5, both plastics were bent by a load in excess of 6 kg. The flexural distance (d) of the EMB was smaller than the flexural distance (d) of the PP when the load was greater than 25 kg. The difference was significant when the load was greater than 30 kg. Therefore, the EMB is considered to have ore mechanical strength than the PP. This is an effective characteristic when making large containers.

8. Density Measurement

The volume of the samples was measured by using the change in volume during purification. The mass was then measured to accuracy of 0.001 g using an electronic scale. The density of both samples was then compared. The results are shown in Table 3. No significant difference in density was discovered.

TABLE 3

| | | PP + | | | Enb. + | | |
|---|---|---|---|---|---|---|---|
| | Weight | Wel. | | PP | Wei. | Enb. | Enb. |
| | (cm3) | (cm 3) | PP (g) | (g/cm3) | (cm3) | (g) | (g/cm3) |
| Test 1 | 10.900 | 13.300 | 2.145 | 0.894 | 13.200 | 2.200 | 0.957 |
| Test 2 | 10.800 | 13.200 | 2.145 | 0.894 | 13.300 | 2.201 | 0.880 |
| Test 3 | 11.000 | 13.300 | 2.145 | 0.933 | 13.300 | 2.200 | 0.956 |
| Test 4 | 11.000 | 13.200 | 2.145 | 0.975 | 13.400 | 2.199 | 0.916 |
| Av | 10.925 | 13.250 | 2.145 | 0.924 | 13.300 | 2.200 | 0.927 |

9. Electric Resistance Measurement

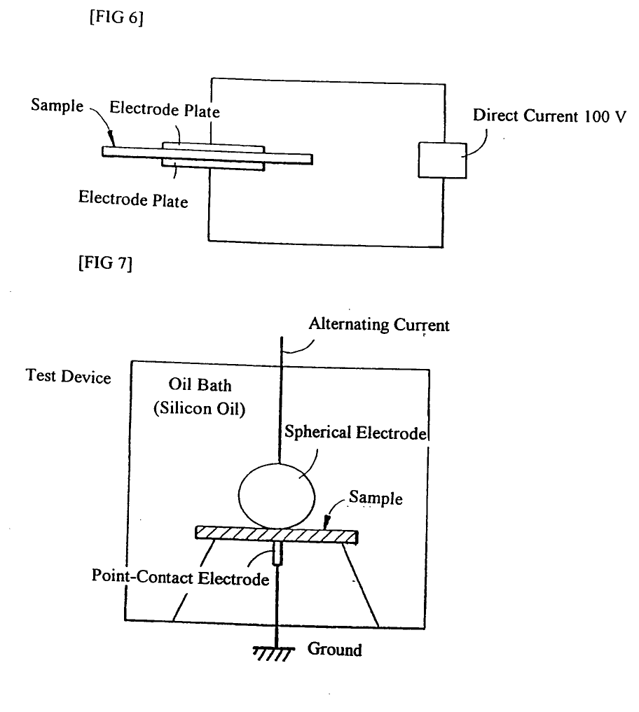

The electric resistance of both resins was measured by applying DC 100 V to a lower electrode plate (80 mm×80 mm, thickness 100 microns) as shown in FIG. 6. the dielectric constant and dielectric loss tangent (tan δ) were also measured after DC 100 V had been applied to the sample for 10 minutes. The results are shown in Table 4.

TABLE 4
Electrical Resistance

| | PP | EMB |
|---|---|---|
| Electrical Resistance | 1.47 × 10¹⁸ (Ω cm) | 2.20 × 10¹⁸ (Ω cm) |
| Dielectric Constant | 2.65 | 2.61 |
| Dielectric Loss Tangent | 0.620 | 0.590 |
| (tan δ) | | |

The electrical resistance of ordinary propylene is 1016 (Ωcm). in this test, the value was a somewhat higher 1018 (Ωcm). however, the EMB had a higher value. Under the same conditions, the electric resistance of EMB was 1.5 times higher than PP. The exact cause is unknown, but it is believed that EMB's fineness (test 2, Electron Microscope Observation) and strength (test 7, Mechanical Strength Test) may have contributed to this effect. The dielectric constants and dielectric loss tangents (tan δ) were not significantly different.

10. Insulation Breakdown Strength Measurement

As shown in FIG. 7, both samples (width 50 mm, length 50 mm, thickness 100 microns) were immersed in a silicon oil bath, and the insulation breakdown voltages were measured. A spherical electrode (diameter 10 mm) was placed on top of the sample, and the sample rested on a linear point-contact electrode. The linear electrode was connected to a ground to prevent an overload when the electricity was applied. The voltage of the current flowing between the spherical electrode and ground wire was the insulation breakdown voltage. This test was performed 19 times to obtain a standard deviation. The results are shown in Table 5 and Table 6. the EMB was discovered to have superior insulating properties because the insulation breakdown voltage of the EMB (Table 5) was 1.2 times higher than the insulation breakdown voltage of the PP (Table 6).:

TABLE 5

| THICKNESS (μm) | VOLTAGE (kv) | ELECTRIC FIELD (ky/mm) |
|---|---|---|
| 80 | 13 | 163 |
| 81 | 14 | 173 |
| 80 | 15 | 188 |
| 81 | 14 | 173 |
| 80 | 11 | 138 |
| 80 | 13 | 163 |
| 80 | 13 | 163 |
| 80 | 14 | 175 |
| 80 | 14 | 175 |
| 80 | 12 | 150 |
| 81 | 11 | 136 |
| 81 | 12 | 148 |
| 80 | 15 | 188 |
| 80 | 15 | 188 |
| 80 | 14 | 175 |
| 79 | 11 | 139 |
| 79 | 15 | 190 |
| 81 | 13 | 160 |
| 80 | 12 | 150 |

TABLE 6

| THICKNESS (μm) | VOLTAGE (kv) | ELECTRIC FELD (ky/mm) |
|---|---|---|
| 81 | 8 | 99 |
| 80 | 7 | 88 |
| 81 | 11 | 136 |
| 81 | 8 | 99 |
| 80 | 13 | 163 |
| 80 | 11 | 138 |
| 81 | 14 | 173 |
| 81 | 11 | 136 |
| 79 | 9 | 114 |
| 79 | 14 | 177 |
| 80 | 12 | 150 |
| 81 | 17 | 210 |
| 80 | 12 | 150 |
| 79 | 12 | 152 |
| 81 | 7 | 86 |
| 81 | 12 | 148 |
| 79 | 12 | 152 |
| 78 | 10 | 128 |
| 79 | 8 | 101 |
| AVERAGE | AVERAGE | AVERAGE ELECTRIC |
| THICKNESS (μm) | VOLTAGE (kv) | FIELD (ky/mm) |
| 80 | 13 | 165 |
| THICKNESS | VOLTAGE | |
| STANDARD | STANDARD | ELECTRIC FIELD |
| DEVIATION | DEVIATION | STANDARD DEVIATION |
| 0.602140 | 1.39758 | 17.6464 |
| AVERAGE | AVERAGE | AVERAGE ELECTRIC |
| THICKNESS (μm) | VOLTAGE (kv) | FIELD (ky/mm) |
| 80 | 11 | 137 |
| THICKNESS | VOLTAGE | |
| STANDARD | STANDARD | ELECTRIC FIELD |
| DEVIATION | DEVIATION | STANDARD DEVIATION |
| 0.970320 | 2.65568 | 32.9902 |

11. Measurement of Water Quality in Tank

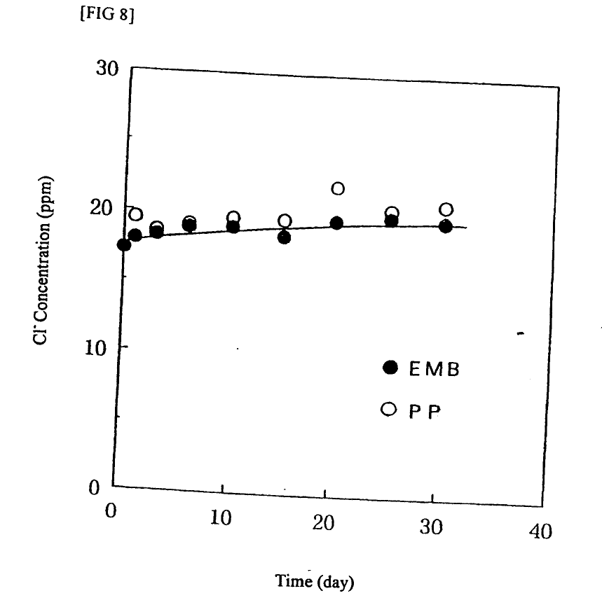

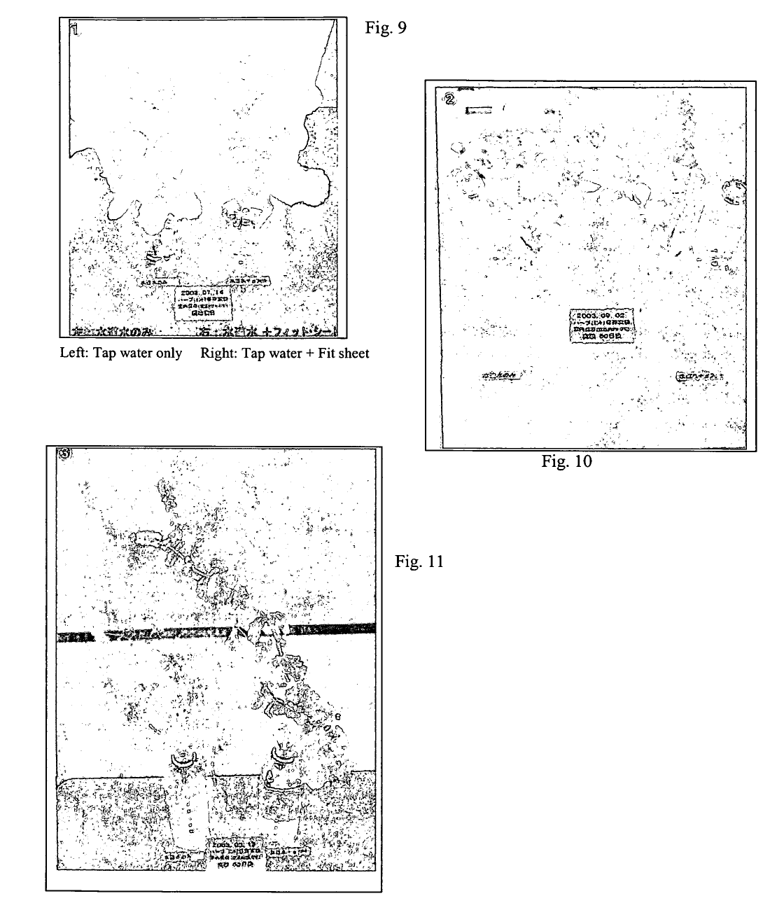

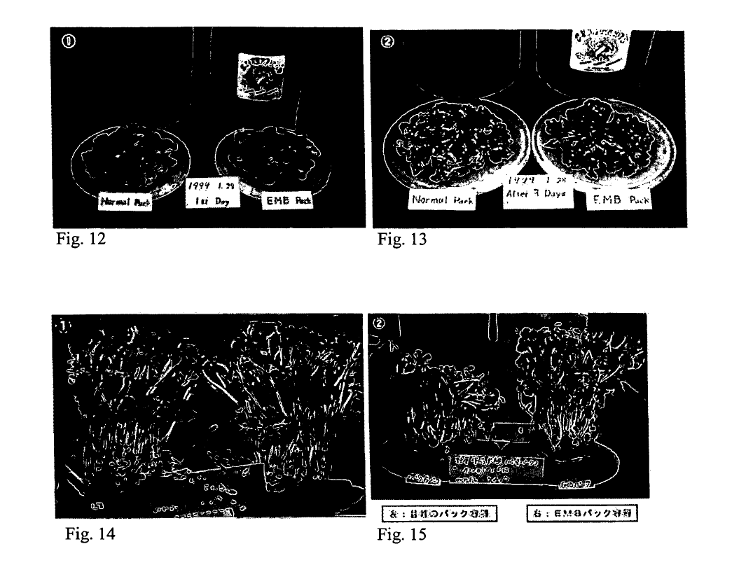

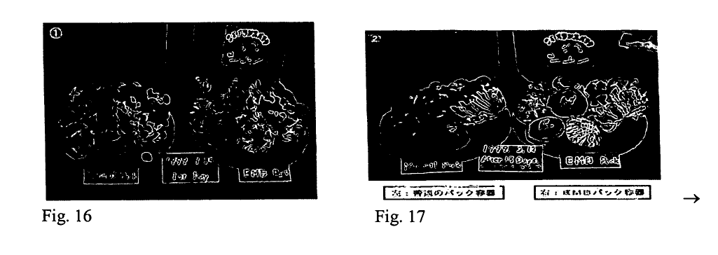

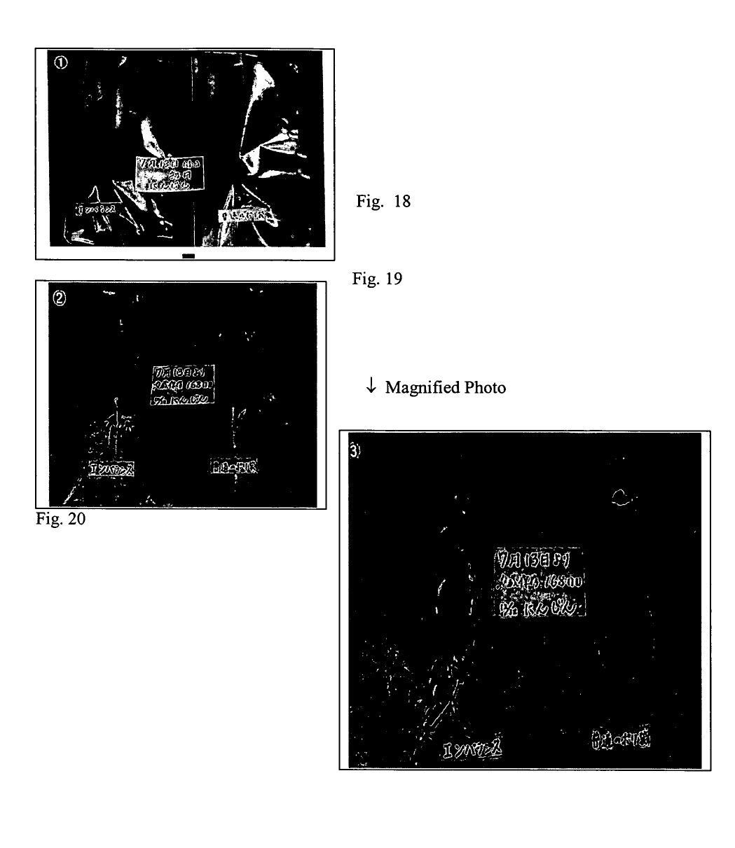

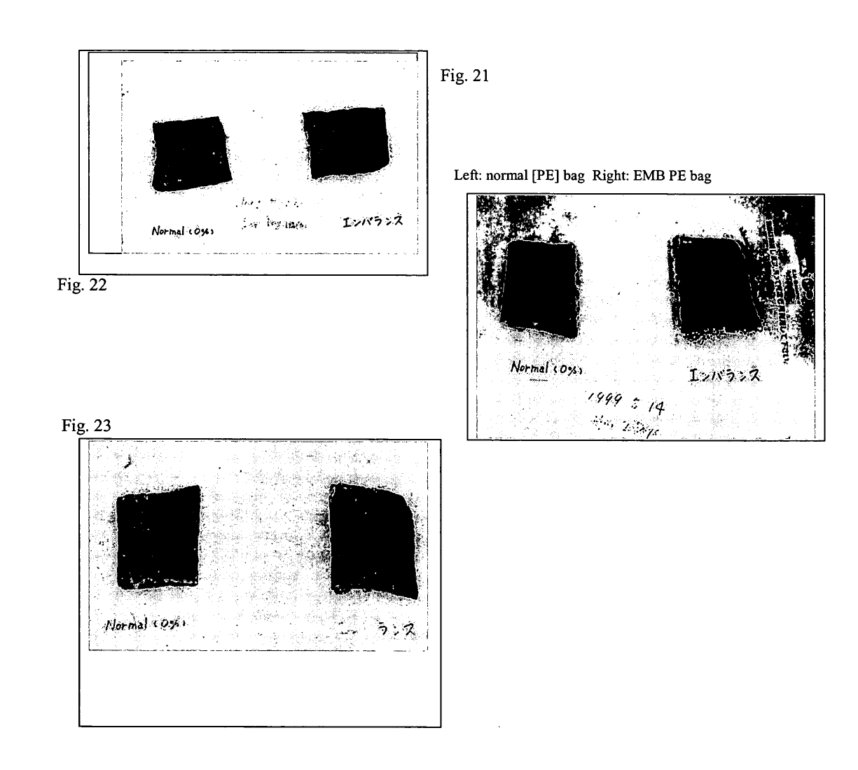

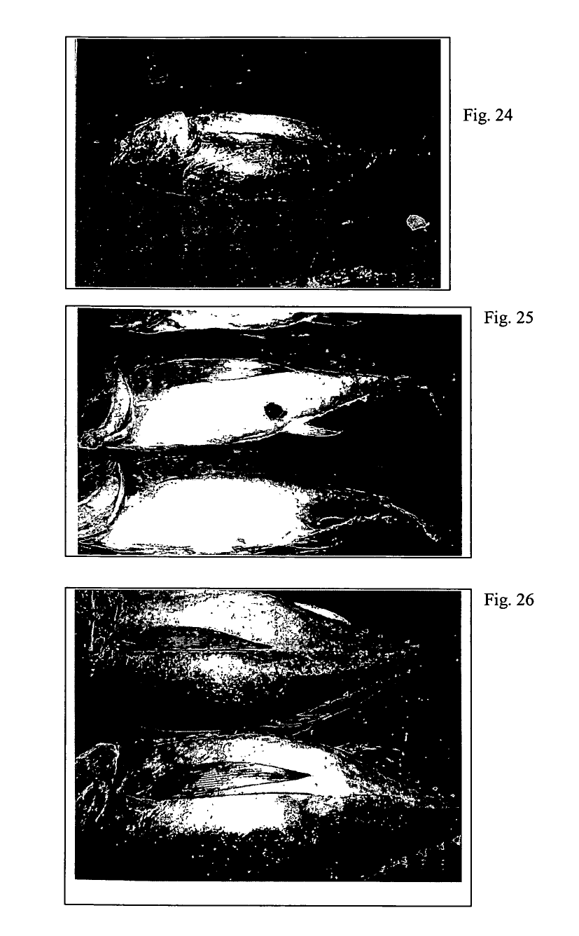

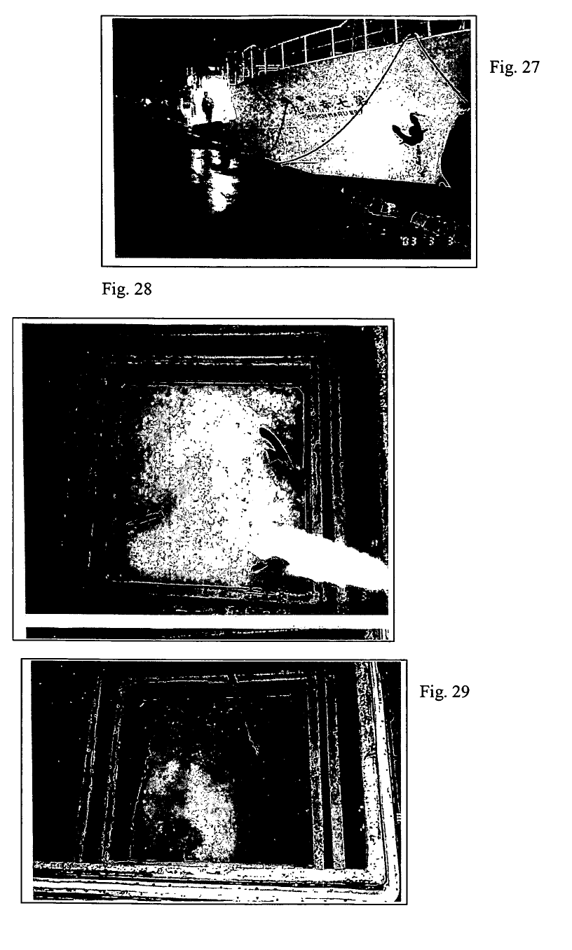

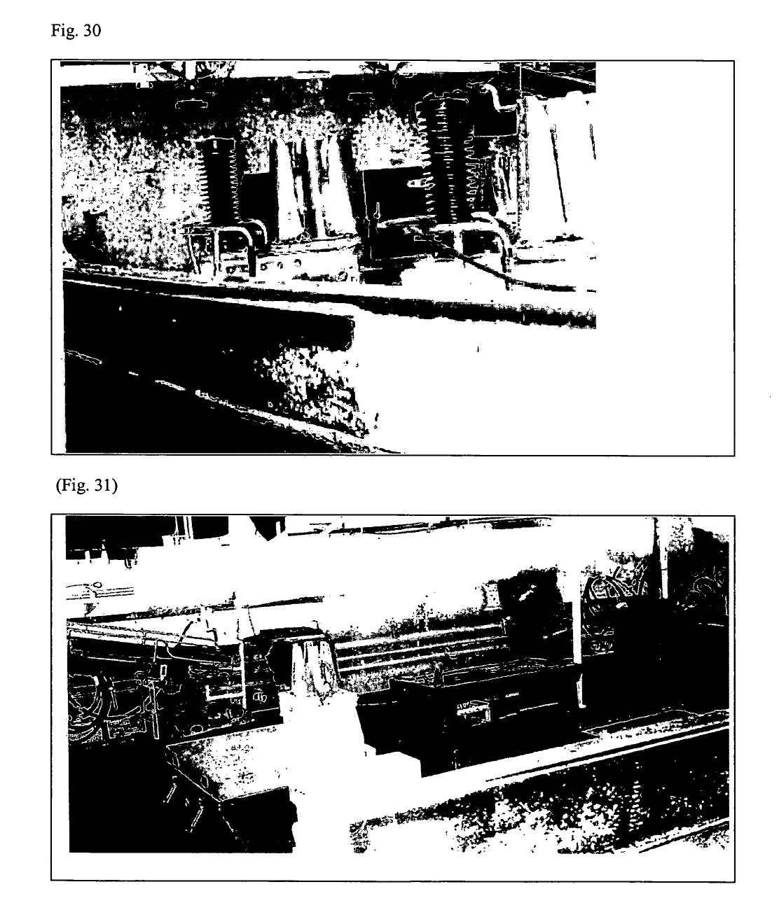

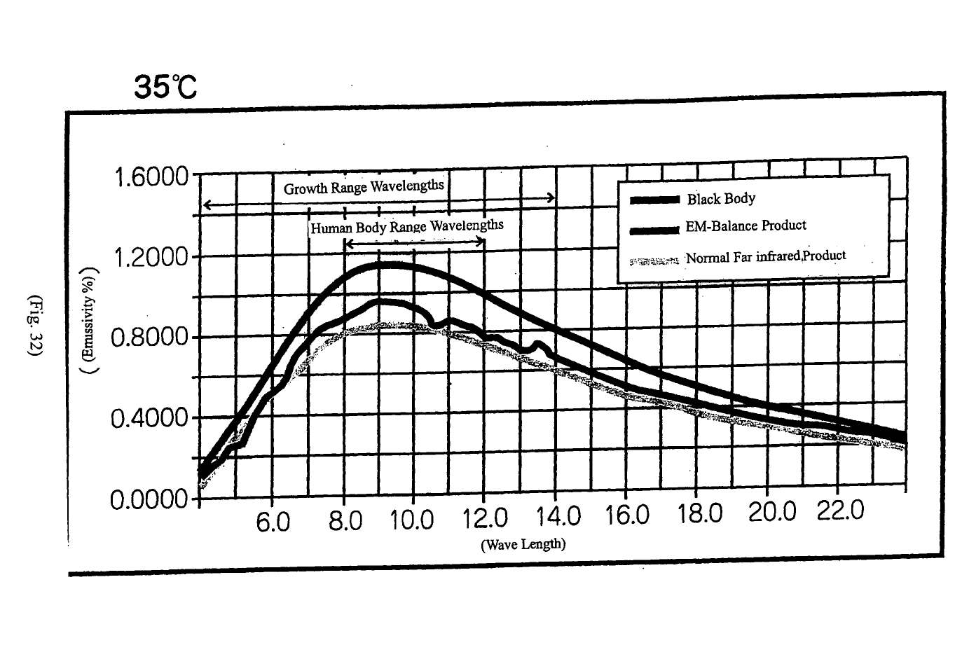

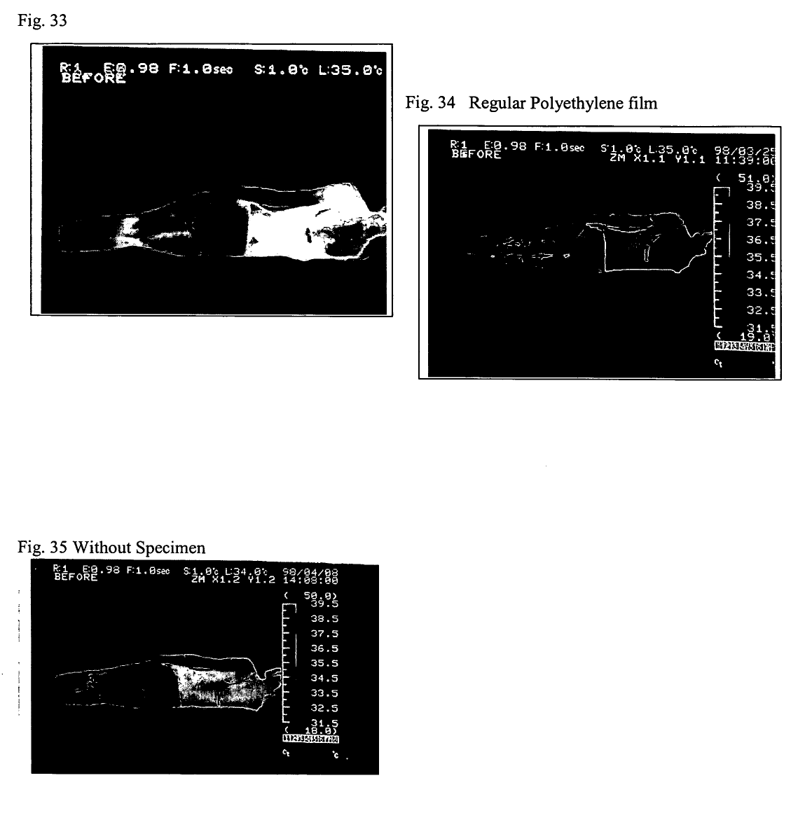

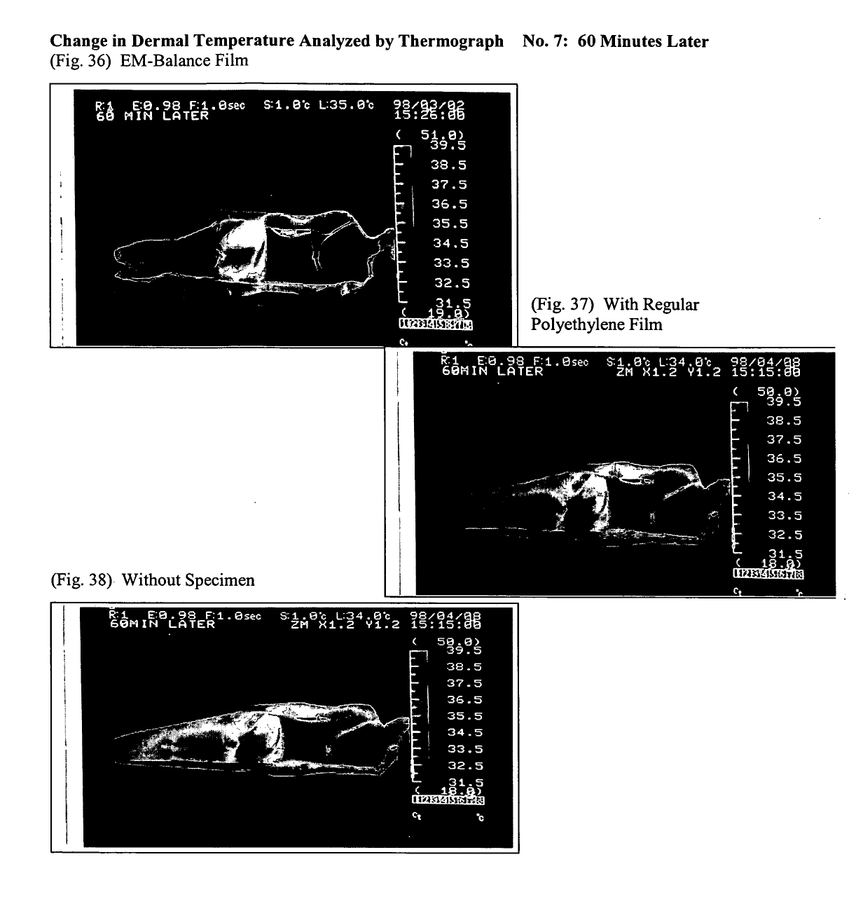

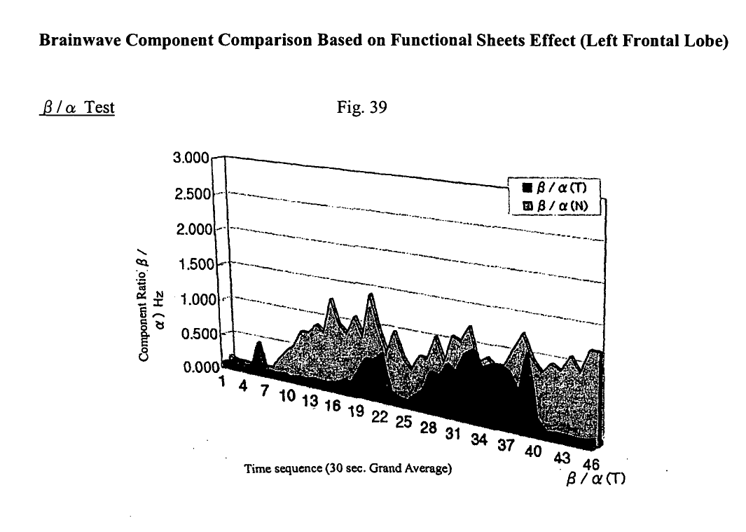

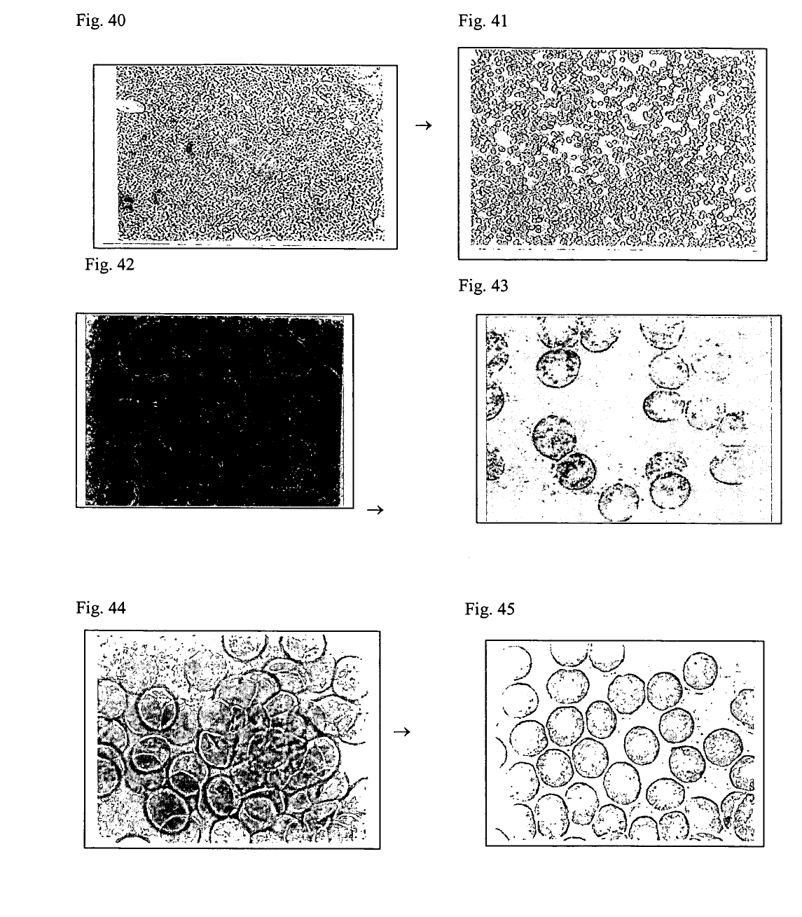

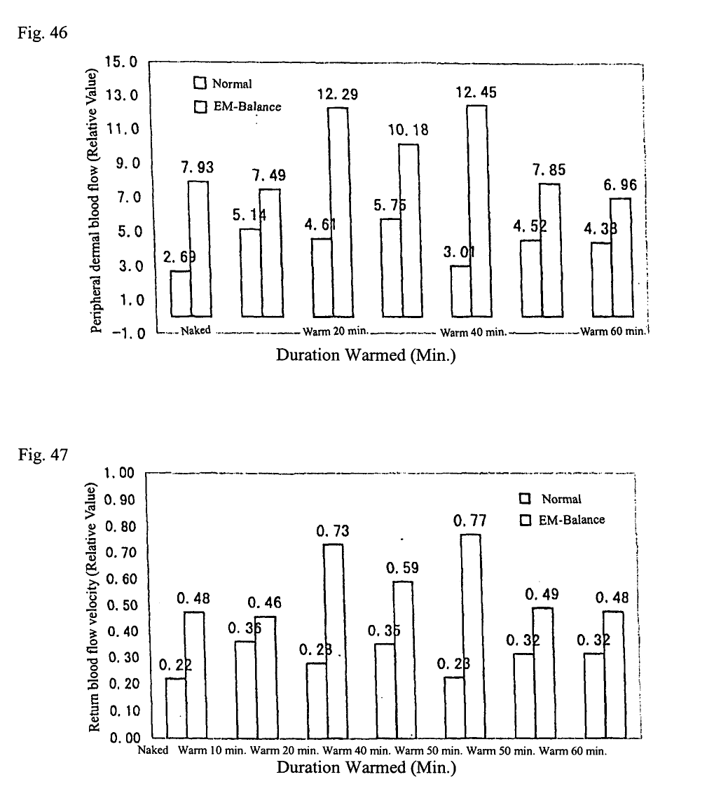

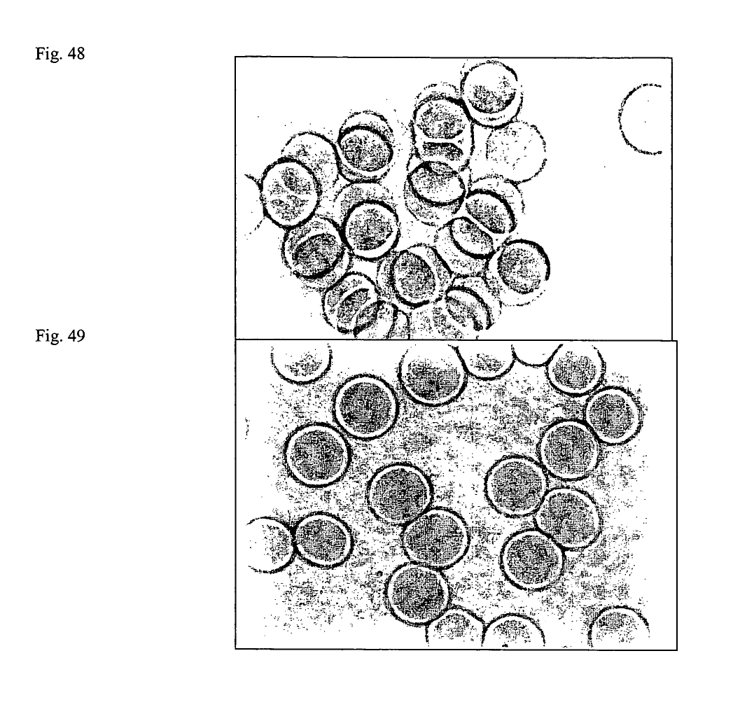

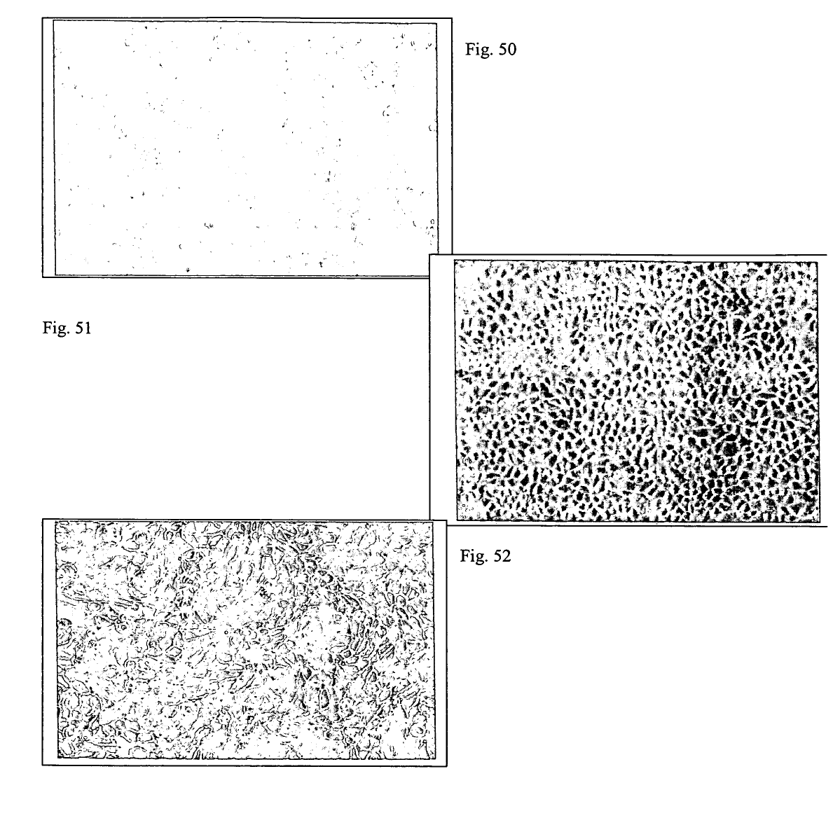

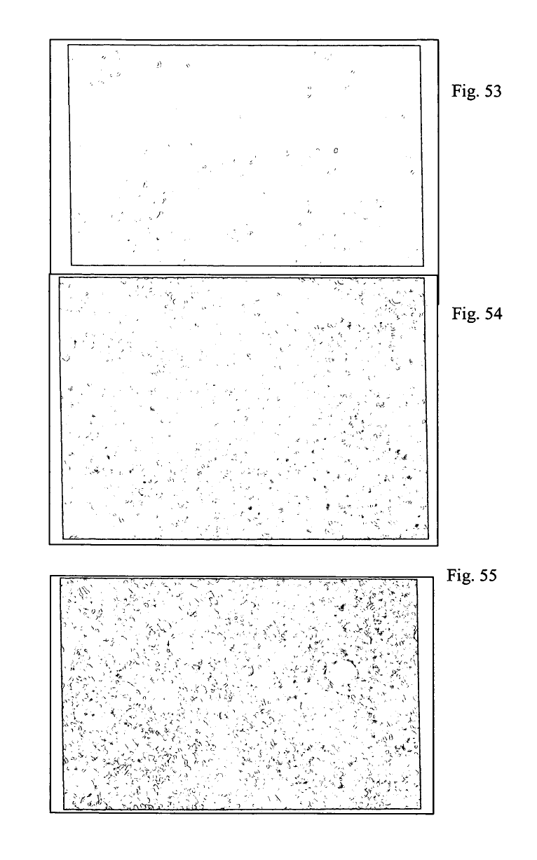

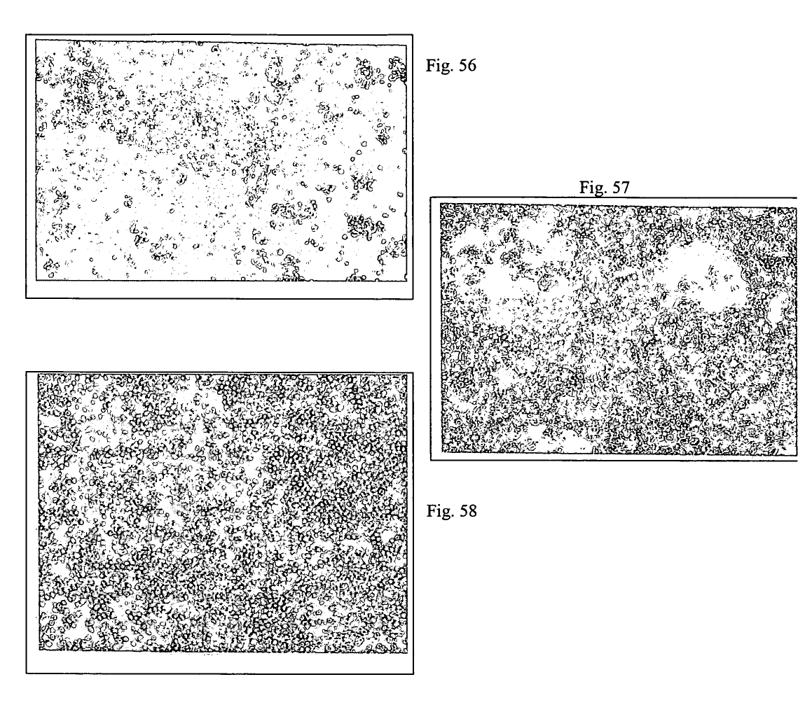

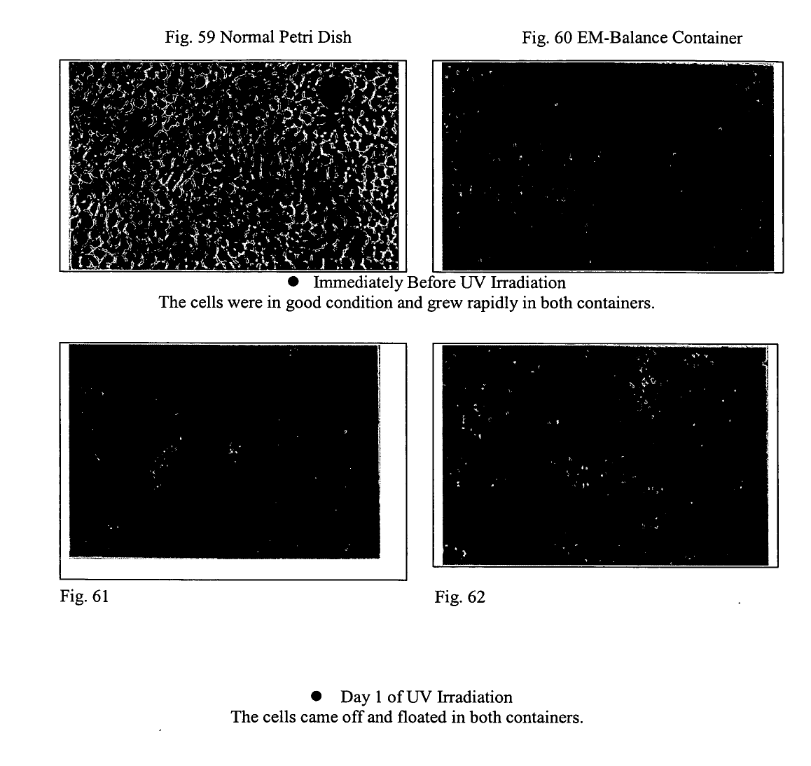

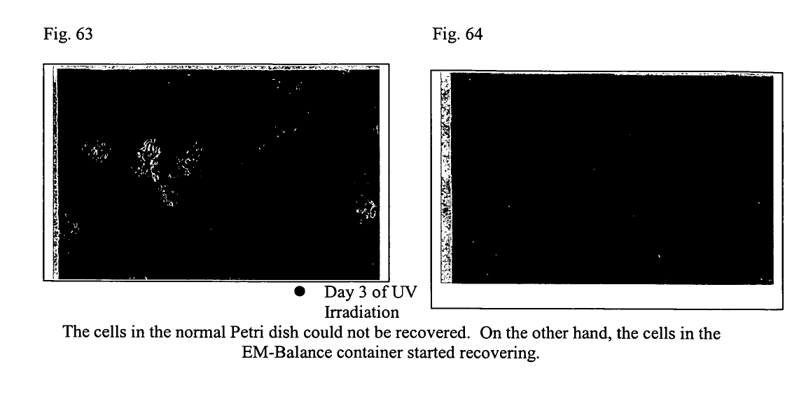

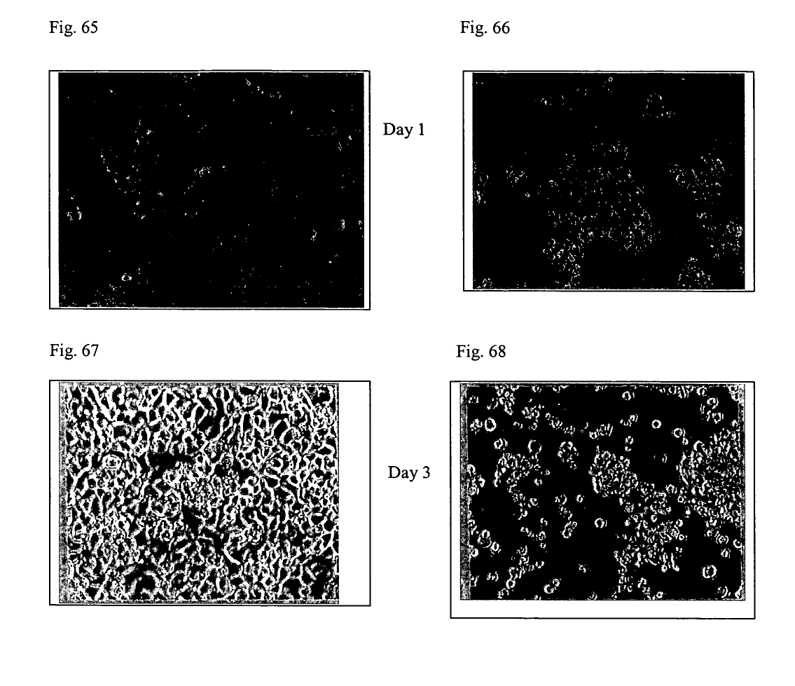

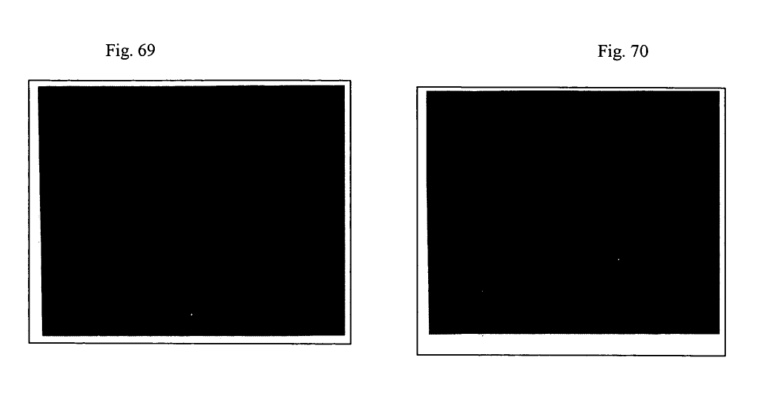

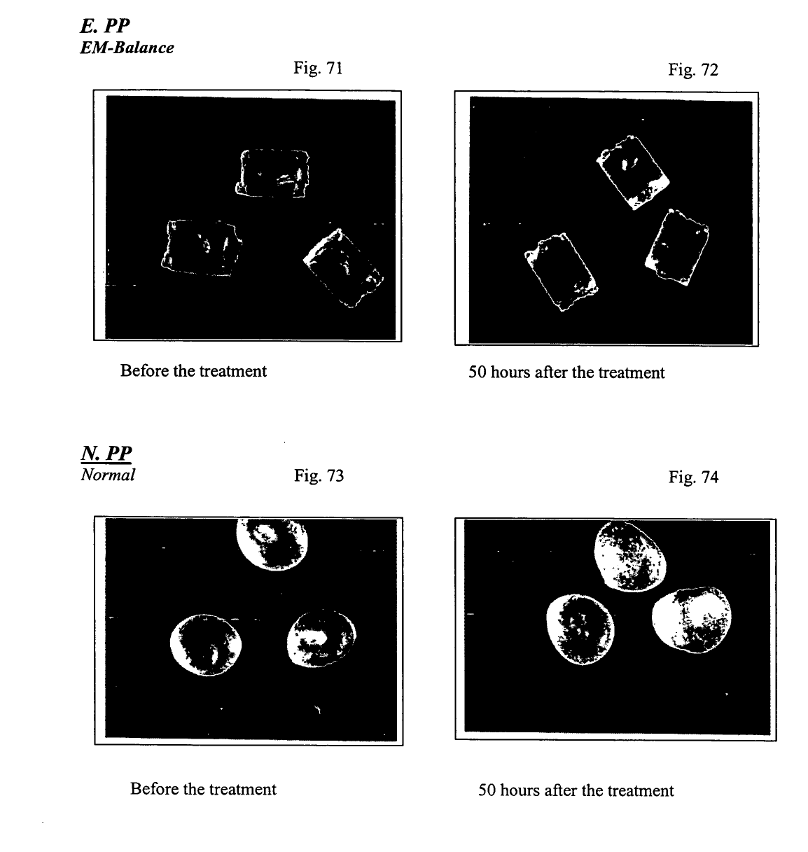

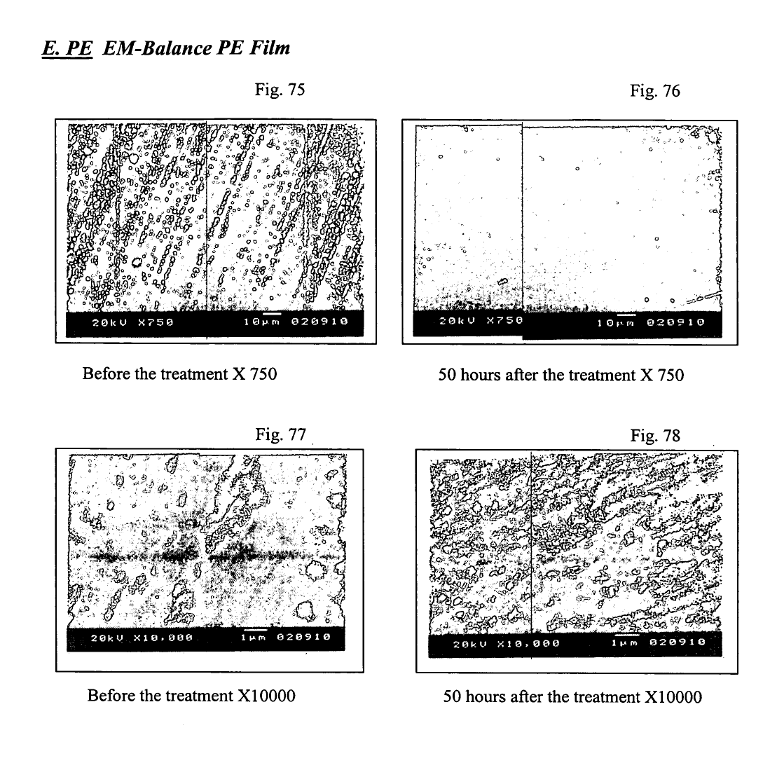

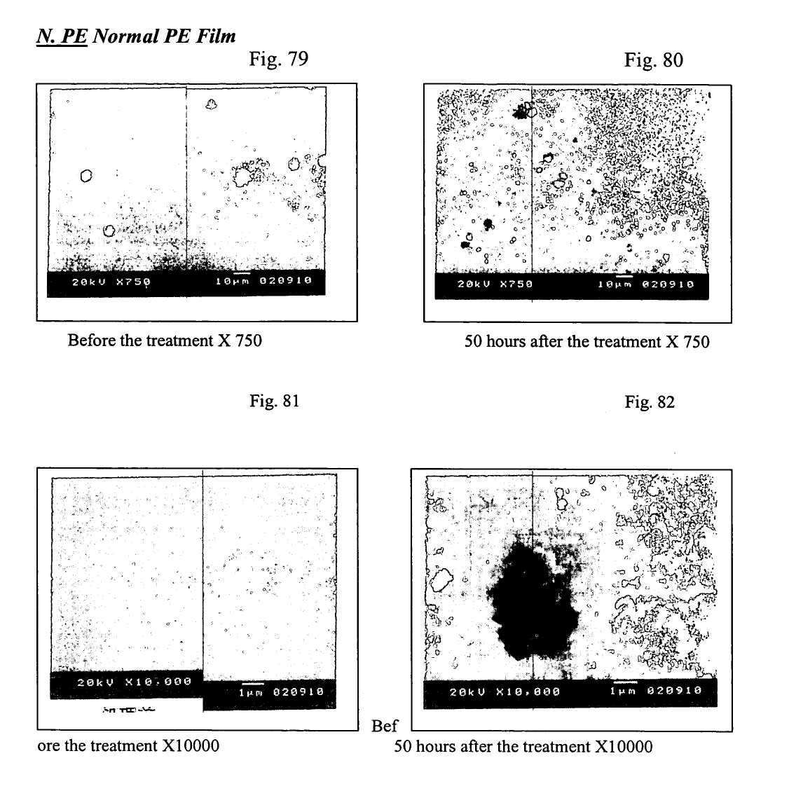

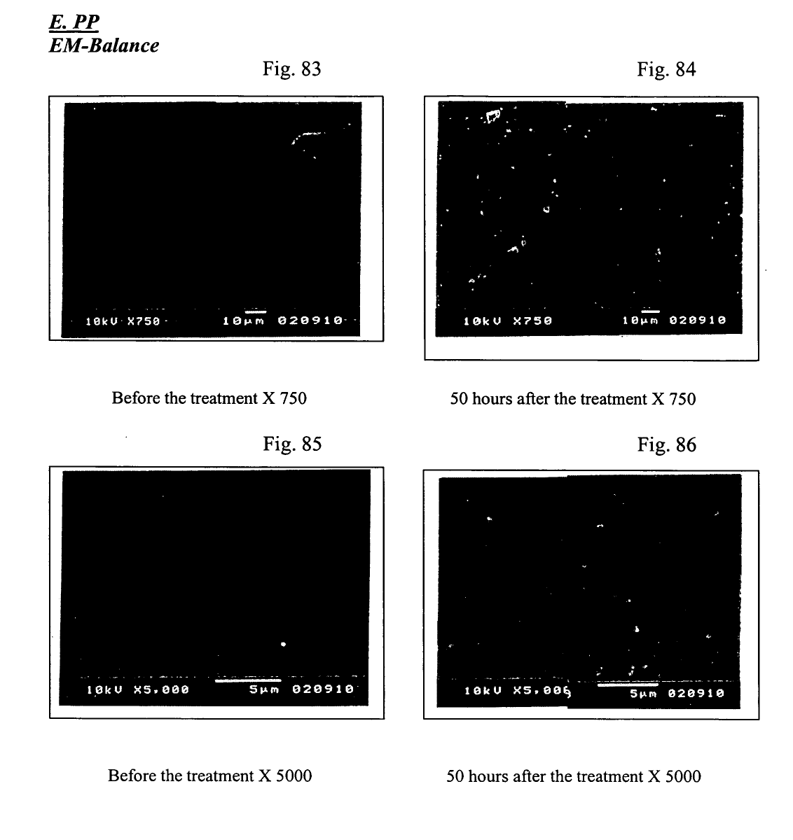

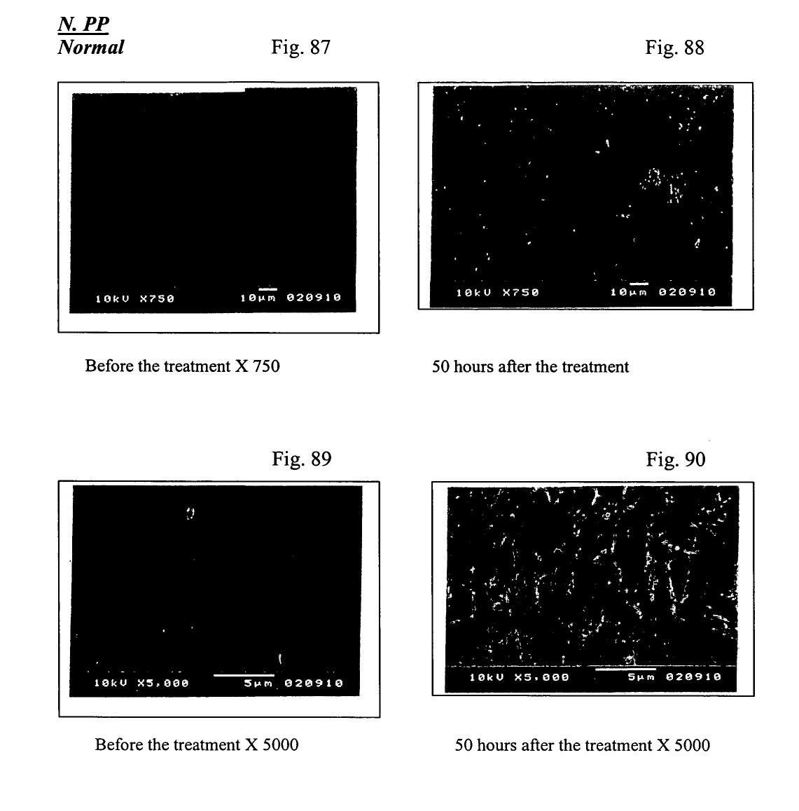

A tank was made from EMB (polyethylene) and another tank was made from ordinary polyethylene (PE). Both tanks were filled with tap water, and the change in the tap water chlorine ion concentration was measured after 1 day, 3 days, 7 days, 14 days and 30 days using an ion chromatograph (DX-500 manufactured by Nippon Dionex Co., Ltd.). The results are shown in FIG. 8. As the figure shows, the tap water chlorine ion concentration in both tanks hardly changed.

Conclusion

In these tests, the differences in the physical properties of the EMB and PP were examined. There were significant differences in melting point, hydrophobia, mechanical strength, electrical resistance, and insulation breakdown strength.

When a resin composition made with purified water with impurities removed or distilled water instead of EM-X water was tested, the physical properties of the EMB remained unchanged. The PP was likewise tested with three different kinds of waters. The physical properties of PP were not affected by the type of water used in its composition.

### EXAMPLE 3

### Storage Test on Fresh Produce

Test 1: Fresh kiwi fruits picked on the same day were placed in a polyethylene bag made from the resin composition using EM-X water (EMB) and in a store-bought polyethylene bag (PE). After storing the fruit for 7 days at 10° C., the amount of reduced Vitamin C (L-ascorbic acid) contained in the fruit was measured using high-performance liquid chromatography. The results are shown in Table 7. As shown in Table 7, the kiwi fruit stored in the polyethylene bag made from the resin composition lost less Vitamin C.

TABLE 7
Results of Reduced Vitamin C Measurement

After Storage
For Seven Days

| Component Detected | Initial Day | EMB | PE |
|---|---|---|---|
| Reduced Vitamin C | 66.6 | 54.4 | 42.9 |

Test 2: Here, the kiwi fruits in Test 1 were replaced by cherry tomatoes. After 7 days, the amount of reduced Vitamin C (L-ascorbic acid) and the sugar content of the tomatoes were measured. The sugar content of the tomatoes was measured using a refractometer. The results are shown in Table 8. As shown in Table 8, the cherry tomatoes stored in the polyethylene bag made from the resin composition lost less Vitamin C and sugar content.

TABLE 8
Results of Reduced Vitamin C and Sugar Content Measurements

After Storage
For Seven Days

| Component Detected | Initial Day- | EMB | PE |
|---|---|---|---|
| Reduced Vitamin C | 73.7- | 70.0 | 67.7 |
| Sugar Content | 6.0 | 8.2 | 7.5 |

Test 3: Here, the kiwi fruits in Test I were replaced by raw meat. After 7 days, the amount of acetic acid, acetone and 2,3-butanediol was measured. The measurements were performed using ¹H-NMR. The results are shown in Table 9. As shown in Table 9, more acetic acid, acetone and 2,3-butanediol was detected in raw meat stored in the ordinary polyethylene bag. The presence of these chemicals accelerates the rate of putrefaction.

TABLE 9
Results of Concentration Measurements From Raw Meat

After Storage
For Seven Days

| Component Detected | Initial Day | EMB | PE |
|---|---|---|---|
| Acetic Acid | 0.2 | 0.5 | 2.1 |
| Acetone | 0 | 0.1 | 0.4 |
| 2,3-Butanediol | 0 | 0 | 2.3 |

Test 4: Here, the kiwi fruits in Test 1 were replaced by spinach. After 7 days, the amount of water released by the spinach was measured. The measurements were performed using ¹H-NMR. The results are shown in Table 10. As shown in Table 10, more water was released from the spinach in the ordinary polyethylene bag. The amount of water in the released by the breakdown of spinach tissue is a good indicator of putrefaction. The amount of water in the polyethylene bag made from the resin composition of the present invention was essentially unchanged.

TABLE 10
Results From Measurements of Spinach Water

After Storage
For Seven Days

| Initial Day | EMB | PE |
|---|---|---|
| 5.0 | 5.9 | 27.9 |

Test 5: A Tupperware container was made from the resin composition and an ordinary polyethylene container was purchased at a store. Bean sprouts were placed in these containers. After storing the containers for 7 days at 10° C., the contents were examined. The bean sprouts stored in the store-bought polyethylene container made from the resin composition had begun to decay, whereas the bean sprouts stored in the container made from the resin composition were fresh and had actually grown.

Test 6: Here, the bean sprouts in Test 5 were replaced by shiitake mushrooms. After a week, the shiitake mushrooms stored in the store-bought polyethylene container had turned W black, had become soft to the touch, and smelled of decay. The shiitake mushrooms stored in the container made from the resin composition, on the other hand, had hardly changed color. The mushrooms were still elastic to the touch and did not smell of decay.

It is clear from Tests 1 through 6 that fresh produce stored in the bags and containers made from the resin composition stay fresher longer than produce stored in ordinary polyethylene bags and containers.

Anti-Rust Effect of the Resin Compositions o: the Present Invention

The resin composition of the present invention is ideal from the standpoint of preventing the putrefaction of fresh foods and improving mechanical strength. Also the antioxidizing substances (EM-X) in an embodiment of the resin composition of the present invention have been reported in a scholarly study to have a rustproofing effect. (See “Changes in the Weight of Metals Due to the Rustproofing Effect of Solutions Containing Effective Microorganism Fermentation Substances” by members of the Department of Science and cultural Department at Ryukyu University in the Technical Report of the Electronic Communication Society, Jun. 27, 1997, pp. 33-38.) In this study, it was reported that steel plates immersed in EM-X water did not experience a decrease in weight due to red rust. Therefore, resin compositions containing EM-X in the present invention also can be used to prevent metals from rusting. For example, the resin compositions of the present invention can be expected to both insulate and rustproof electrical wiring. If the resin compositions of the present invention are used to line pipes, the metal pipe can be expected to remain free of rust even if water gets between the metal pipe and the inner lining. As discussed previously, the present invention offers Novelty of Material Development Technology. In the reaction field to which the critical state (high temperature-high pressure) plus vibrations are imparted, an olefin resin is allowed to react with an antioxidant solution to develop an oxidation—retarding plastic material (EM-Balance). The present invention also offers Novelty in the Material. When this newly developed plastics (EM-Balance) is used as a food packaging material, it inhibits the oxidative process which causes food degradation and decay. Additionally, it enhances the antioxidant strength (vital power) of the food itself. Since there is not any residual contaminant in this plastic material, it is free from (illegible) problems. That is to say, it is a superior material safe for humans, plants and the environment. The research results which show that the food, water and the like, preserved with this EM-Balance are also good for health are also accumulated. Further experiments and tests results were developed in a variety of applications of the present invention (its products referred to as “EMB” or “EM-Balance”

Hydrothermology

Unique features of EMB can be explained in terms of hydrothermology. Even though water is the best medium for chemical reactions, attention has been paid only to changes in solutes and the reaction products. It was the extremely complex inner structure of water that turned scientists away from studying water as a solvent.

If the earth controls itself as a living body, its fundamental substance is “water”. Therefore, the “core science and technology for controlling oneself” must include ways to control water. It can be said that whether human beings can control themselves or not depends on whether human beings can control water.

Hydrothermology is the science of water (aqueous solution) at high temperature and pressure. The idea of water at high temperature and high pressure tends to give one an impression that hydrothermology is a science that studies an aqueous system under special conditions. In contrast, our daily life conditions, namely 0-60° C. at 1 atmospheric pressure, are more special to water than hydrothermal conditions. It is the very science studying water under the conditions in which pressure and temperature are varied freely that can provide a true profile of water.

It can be stated that hydrothermology is an interdisciplinary technical study of water in which basic sciences of conventional classifications such as physics, chemistry, physical geography and earth science are intertwined with many engineering disciplines.

Water can be used as a medium for many reactions. A hydrothermal solution can be a desirable medium for any type of reaction when it is introduced in an appropriate manner.

This gives rise to a need for awareness of each researcher who is engaged in hydrothermal development with respect to the direction in which he balance is achieved between the essence of human desire and the social system. See Hydrothermology Handbook Editorial Committee, “Hydrothermology Handbook”, by Gihodo-Shuppan (1997)

Weight Change in Metal Caused by Rust-Preventive Effect in the olution of Useful Micro-Organism Fermented Material

This test was conducted by Giichi Hoshimura, Nobuyuki Sato and Teruo Hika, Faculty of Science and Engineering, Nihon University, Faculty of Agriculture, Ryukyu University.

The ICP Spectroscopic Analysis of EM-X was conducted. Table 11 shows the qualitative analysis results of EM-X with the ICP spectroscopic analysis. It was confirmed from the table that EM-X contained 40 types of metal elements. Most of them are believed to be the minerals originated from plants. The quantitative analysis was further carried out on 5 types of materials which are believed to be contained in great quantities in EM-X. The quantitative analysis results showed K; 306 (μg/ml), P; 170 (μg//ml), Na; 106 (μg/ml), Mg; 85 (μg/ml) and Ca; 11 (μg/ml). It is surmised that the electric conductivity increases to inhibit rusting of iron because of high contents of these minerals in EM-X.

TABLE 11
ICP Spectrum Analysis on EM·X.

| Li | B | Na | Mg | Al | Si | P | K | Ca | Ti |
|---|---|---|---|---|---|---|---|---|---|
| ≧2.5 | ≧1000 | ≧250 | ≧2000 | ≧10 | ≧10 | ≧7000 | ≧5000 | ≧2000 | ≧1 |
| V | Cr | Mn | Fe | Co | Ni | Cu | Zn | Ga | Ge |
| ≧5 | ≧5 | ≧200 | ≧50 | ≧5 | ≧5 | ≧100 | ≧5 | <30 | <30 |
| Se | Sr | Zr | Nb | Mo | Ag | Cd | In | Sn | Sb |
| ≧25 | ≧10 | ≧10 | <3 | ≧5 | <7.5 | ≧1 | <40 | ≧15 | ≧10 |
| Te | Ba | La | Ce | Ta | M | Pt | Au | Pb | Bi |
| <25 | ≧5 | <7.5 | <30 | <30 | <250 | ≧10 | <7.5 | ≧10 | ≧20 |

Freshness Maintenance Effect by EMB Packaging Material

This test was conducted by Water Science Research Association, Osaka, Japan.

Test Sample: 1. Raw mackerel

2. Raw meat
   Test Method:
   1. Confirmation of Raw Mackerel Freshness Maintenance Effect (Confirmation of Component Change).

The sample was placed in the EMB packaging material and control packaging material, and stored in a refrigerator for 4 days. Then the sample was cut to pieces, 10 g was weighed up from each sample and 25 ml of distilled water was added to the sample with stirring. After the sample was left standing for 1 hour, the supernatant liquid was subjected to centrifugation to collect a clear liquid, and the component was measured with ¹H-NMR. For the internal standard, the 1 m Mole TSP solution was used.

2. Confirmation of Raw Meat Freshness Maintenance Effect (Confirmation of Component Change)

The sample was placed in each packaging material and the sample preserved for 7 days in a refrigerator was treated in the same way as above to measure the component with ¹H-NMR.

Results and Discussion

1. Change in Raw Mackerel Component Concentration

The measurement results of raw meat samples are shown in the graph and Table 1. After the preservation for 4 days, as compared to the EMB preservation, detected in the control packaging material preservation are great quantities of acetic acid and trimethylamine (cause for a fishy smell). It can be surmised that decay is proceeding.

2. Change in Raw Meat Component Concentration

The measurement results of the raw meat sample are shown in the graph and Table-2. After 7 day preservation, acetic acid, acetone and 2,3-butanediol are detected in greater quantities in the control packaging material preservation than in the EMB preservation. Thus it shows that decay is proceeding. It can be seen from the above results that, as compared to the control packaging material, the EMB packaging material provides a preservation effect.

TABLE 12
Measurement Results on Raw Mackerel Component Concentration

Unit: mMol

Stored for 4 Days

| Detected Component | Day 1 | EMB | Control |
|---|---|---|---|
| Lactic acid | 44.9 | 41.4 | 40.4 |
| Alanine | 1.2 | 2.0 | 2.1 |
| Acetic acid | 0.2 | 0.3 | 1.3 |
| Trimethylamine | 0.1 | 0.5 | 1.2 |
| Cleatinine | 20.0 | 17.7 | 16.8 |
| Trimethylamineoxide | 2.0 | 2.0 | 1.2 |
| Taurine | 1.0 | 2.6 | 2.1 |
| Glycine | 0.7 | 0.8 | 0.8 |
| Hstidine | 16.0 | 16.4 | 13.5 |

TABLE 13
Measurement Results on Raw Meat Component Concentration

Unit: mMol

Stored for 7 Days

| Detected Component | Day 1 | EMB | n \hat{ } 1′ a - /1/ |
|---|---|---|---|
| Ethanol | 2.0 | 2.3 | 0.9 |
| 2,3-butanediol | — | — | 0.4 |
| Lactic acid | 31.9 | 33.7 | 15.8 |
| Alanine | 1.6 | 2.1 | 1.2 |
| Acetic acid | 0.2 | 0.5 | 2.1 |
| Cleatinine | 12.8 | 12.5 | 9.2 |
| Taurine | 1.8 | 1.7 | 1.0 |
| Formic acid | 3.2 | 2.9 | 2.0 |
| Trimethylamineoxide | 1.9 | 2.2 | 1.0 |
| Succinic acid | 0.5 | 0.5 | 0.2 |
| Acetone | — | 0.1 | 0.4 |

Freshness Maintenance Effect by EMB Packaging Material

This test was conducted by Water Science Research Association, Osaka, Japan.

Test Samples: 1. Steamed Rice

2. Spinach
   Test Method:
   1. Confirmation of Steamed Rice Freshness Maintenance Effect (Confirmation of Component Change)

The steamed rice sample was divided into two equal parts, one of them placed into the EMB packaging material and the other into the control packaging material, and they were left standing at room temperature. After 20 days, 10 g of each sample was weighed up, 25 mg of distilled water was added to each of them with stirring, and they were left standing for 1 hour. Afterwards, the supernatant liquid was subjected to centrifugation to collect the clear liquid and the component was measured with ¹H-NMR. For the internal standard, the 1 m Mole TSP solution was used.

2. Confirmation of Spinach Freshness Maintenance Effect (Confirmation of Relaxation Time Change of Tissue Water)

The sample was placed in each packaging material, the tips of leaves of spinach that were preserved in a refrigerator for a week were collected, and the relaxation time (T₂) of the tissue water was measured with ¹H-NMR.

Results and Discussion

1. Change in Rice Component Concentration

The measurement results of rice samples are shown in FIGS. 1˜3 and Tables 1. Although some changes in acetic acid and alanine are observed, there is no particular problem. However, acetone is detected from the control packaging material, and it is believed that decay is proceeding. This is not detected in the EMB packaging material, and it is believed that decay is proceeding. This is not detected in the EMB packaging material.

2. Change in Relaxation Time of Spinach Tissue Water

The measurement results of relaxation time are shown in FIGS. 4˜6 and Table 2. As compared to the initial period, the relaxation time of the sample preserved with the control packaging material becomes long. This means that the tissue of spinach is destroyed and free water increases. The increase in the relaxation time in the case of preservation with the EMB packaging material is slight. From the above results, it can be seen that, as compared to the control packaging material, the EMB packaging material has a preservation effect.

TABLE 14
Measurement Results on Rise Component Concentration

Unit: mMol

| Period Stored | Packaging Material | Alanine | Acetic Acid | Acetone |
|---|---|---|---|---|
| Day 1 | | 0.17 | 0.17 | — |
| Day 20 | EMB | 0.35 | 0.20 | — |
| | Control | 1.05 | 0.09 | 0.45 |

TABLE 15
Measurement Results on Relaxation Time of Spinach Tissue Water

| Period Stored | Packaging Material | T₂ (msec) |
|---|---|---|
| Day 1 | | 5.0 |
| Day 7 | EMB | 5.9 |
| | Control | 27.9 |

Analysis Test Evaluation Statement

The analysis test was conducted with EM-Balance PE Bag by Japan Food Research Laboratories (The Non-Profit Organization) on Nov. 10, 1997. The result of the test is as follows.

TABLE 16
Analysis Test Results

| | | Detection | | Analysis |
|---|---|---|---|---|
| Analysis Test Item | Results | Limit | Note | Method |
| Tools and Container | | | 1 | |
| Packaging Standard | | | | |
| Test | | | | |
| (Synthetic Resin) | | | | |
| General Standard | | | | |
| Material Quality Test | OK | | | |
| Cadmium and Lead | | | | |
| Elusion Test | OK | | | |
| Heavy Metal | OK | | | |
| Potassium | (≦0.5 ppm) | | | |
| Permanganate | | | | |
| Consumption | | | | |
| Individual Standard | | | | |
| (Polyethylene) | | | | |
| Elusion Test | OK (≦9.0 ppm) | | | |
| Evaporation Residue | OK (≦5 ppm) | | | |
| (n-heptane) | | | | |
| Evaporation Residue | OK (≦5 ppm) | | | |
| (20% Ethanol) | | | | |
| Evaporation Residue | OK (≦5 ppm) | | | |
| (Water) | | | | |
| Evaporation Residue | | | | |
| (4% Acetic Acid) | | | | |

Note:
The test was performed in accordance with 3.D.2 “Synthetic Resin - Made Tools or Container Packaging” in the Food and Additive Standard (Ministry of Health Notice No. 370, 1959). Segment: Temperature used: ≦100° C.

Analysis Test Evaluation Statement

The analysis test was conducted with EM-Balance PE Bag by Japan Food Research Laboratories (The Non-Profit Organization) on Oct. 24, 1997. The result of the test is as follows.

TABLE 17
Analysis Test Results

| | | Detection | | Analysis |
|---|---|---|---|---|
| Analysis Test Item | Results | Limit | Note | Method |
| Tools and Container | | | 1 | |
| Packaging Material | | | | |
| Standard Test | | | | |
| (Synthetic Resin) | | | | |
| General Standard | | | | |
| Material Quality Test | OK | | | |
| Cadmium and Lead | | | | |
| Elusion Test | OK | | | |
| Heavy Metal | OK | | | |
| Potassium Permanganate | (≦0.5 ppm) | | | |
| Consumption | | | | |
| Individual Standard | | | | |
| (Polyethylene) | | | | |
| Elusion Test | | | | |
| Evaporation Residue | OK | | | |
| (n-heptane) | | | | |
| Evaporation Residue | (≦5 ppm) | | | |
| (20% Ethanol) | | | | |
| Evaporation Residue | OK | | | |
| (Water) | | | | |
| Evaporation Residue | (≦5 ppm) | | | |
| (4% Acetic Acid) | OK | | | |
| | (≦5 ppm) | | | |
| | OK | | | |
| | (≦5 ppm) | | | |

Note:
The test was performed in accordance with 3.D.2 “Synthetic Resin - Made Tools or Container Packaging” in the Food and Additive Standard (Ministry of Health Notice No. 370, 1959). Segment: Temperature used: ≦100° C.

TABLE 18
Water Quality Test Evaluation

4 Ho No. 93-25
Apr. 21, 1997

The specimen submitted to the office on Apr. 8, 1997 was tested and evaluated by Shijonawate
Office, Health Center, Osaka-fushown below.
(Objective of the Inspection: Tap Water, Special)
Water Quality Test Evaluation Sheet

| Place Collected | The same as above. | | | At cost |
|---|---|---|---|---|
| Type | Other tap water Filtered water | | | |
| Date Water was | Apr. 8, 1997 | Weather | Previous | Rain |
| Collected | | | Day | |
| Date Tested | Apr. 8, 1997˜Apr. 17, 1997 | | Day Tested | Clear |

| | | Water | | | | Water | |
|---|---|---|---|---|---|---|---|
| | | Quality | | | | Quality | |
| | Item | Standard | Specimen | | Item | Standard | Specimen |
| | Temp. (°) | | | 26 | 1,3- | ≦0.002 mg/l | . . . |
| | | | | | dichloropropene | | |
| | Water Temp. (°) | | | 27 | Simazin | ≦0.003 mg/l | . . . |
| 1 | General germs | ≦100 in 1 ml | 0 | 28 | Thiuram | ≦0.006 mg/l | . . . |
| 2 | E. coli group | Not | (−) | 29 | Thiobencarb | ≦0.02 mg/l | . . . |
| | | detected. | | | | | |
| 3 | Cadmium | ≦0.01 mg/l | . . . | 30 | Zinc | ≦1.0 mg/l | 0.018 |
| 4 | Mercury | ≦0.0005 mg/l | . . . | 31 | Iron | ≦0.3 mg/l | <0.01 |
| 5 | Selenium | <0.01 mg/l | . . . | 32 | Copper | ≦1.0 mg/l | 0.019 |
| 6 | Lead | ≦0.05 mg/l | <0.005 | 33 | Sodium | ≦200 mg/l | . . . |
| 7 | Arsenic | ≦0.01 mg/l | . . . | 34 | Manganese | ≦0.05 mg/l | <0.005 |
| 8 | Hexavalent | ≦0.05 mg/l | . . . | 35 | Chlorine ion | ≦200 mg/l | 19.6 |
| | chrome | | | | | | |
| 9 | Cyanogen | ≦0.01 mg/l | . . . | 36 | Calcium, | ≦300 mg/l | . . . |
| | | | | | magnesium, | | |
| | | | | | etc. (hardness) | | |
| 10 | Nitrate nitrogen | ≦10 mg/l | 1.11 | 37 | Evaporation | ≦500 mg/l | 135 |
| | and Nitrite | | | | residue | | |
| | nitrogen | | | | | | |
| 11 | Fluorine | ≦0.8 mg/l | . . . | 38 | Anionic | ≦0.2 mg/l | . . . |
| | | | | | surfactant | | |
| 12 | Carbon | ≦0.002 mg/l | . . . | 39 | 1,1, | ≦0.3 mg/l | . . . |
| | tetrachloride | | | | 1-trichloroethane | | |
| 13 | 1,2- | ≦0.004 mg/l | . . . | 40 | Phenols | ≦0.005 mg/l | . . . |
| | dichloroethane | | | | | | |
| 14 | 1,1- | ≦0.02 mg/l | . . . | 41 | Organic | ≦10 mg/l | 2.6 |
| | dichloroethylene | | | | compounds | | |
| | | | | | (potassium | | |
| | | | | | permanganate | | |
| | | | | | consumption) | | |
| 15 | Dichloromethane | ≦0.02 mg/l | . . . | 42 | pH value | 5.8˜8.6 | 7.3 |
| 16 | Cis-1, | ≦0.04 mg/l | . . . | 43 | Taste | not | . . . |
| | 2-dichloroethylene | | | | | abnormal | |
| 17 | Tetrachloroethylene | ≦0.01 mg/l | . . . | 44 | Smell | not | not |
| | | | | | | abnormal | abnormal |
| 18 | 1,1,2- | ≦0.006 mg/l | . . . | 45 | Color | ≦5 | 1 |
| | trichloroethane | | | | | | |
| 19 | Trichloroethylene | ≦0.03 mg/l | . . . | 46 | Turbidity | ≦2 | <0.5 |
| 20 | Benzene | ≦0.01 mg/l | . . . | | | | |
| 21 | Chloroform | ≦0.06 mg/l | 0.0003 | | | | |
| 22 | Dibromo | ≦0.1 mg/l | 0.0005 | | | | |
| | chloromethane | | | | | | |
| 23 | Bromodichloro- | ≦0.03 mg/l | 0.0005 | | | | |
| | methane | | | | | | |
| 24 | Bromoform | ≦0.09 mg/l | <0.0001 | | | | |
| 25 | Trihalomethane | ≦0.1 mg/l | 0.0013 | | Residual | | . . . |
| | | | | | chlorine | | |

Note
The above items are in compliance with the water quality standard.

### EM-Balance Physical Property Test at Kansai University Industrial Technology Institute

### <A Summary of a 15-Page Report>

### April 2000

1. Observation of Resin Surface by Scanning Electron Microscopy(SEM Photographs)

Based on the SEM photographs at 3500 magnification, the surface of EM-Balance [resin] appears to be somewhat more intricate than that of a normal resin.

2. Contact Angle Measurement

A significant difference [between EM-Balance and normal resin] was observed for the contact angle with respect to water. It is concluded that EM-Balance is about 20% more hydrophobic than polypropylene.

3. Ultraviolet Absorption Spectrum (UV Measurement)

No significant difference was observed [between the normal resin and the EM-Balance resin].

4. Infrared Absorption Spectrum (FTIR Measurement)

Both EM-Balance and polypropylene (PP) plastics showed a peak at the same wave length. It is concluded that the two plastics have the same component. However, the infrared absorption peak of the EM-Balance [plastic] was, in all respects, about 40% less than PP [plastic]. It is concluded that the distance between vibrating atoms of the EM-Balance [plastic] is greater than that of PP, and the partial charge of the EM-Balance [plastic] is smaller than that of PP [plastic].

5. Quality of Water in a Tank

Being tested.

6. Mechanical Strength Test

Under heavy loads, EM-Balance demonstrated a higher mechanical strength than PP. EM-Balance plastic is stronger, which is a useful characteristic for [storage] containers or similar products. (on average. 30%-40% up at a load of 30 Kg or more)

7. Density Measurement

Densities of EM-Balance [PP] and [normal] PP were compared and it was concluded that they were almost the same.

8. Electric Resistance Measurement

While normally PP has the order of magnitude of 1016 (Ωcm), the value obtained in this experiment was as high as 1018. The EM-Balance value was higher than that of PP: the EM-Balance demonstrated an electric resistance of about 1.5 times as much as PP. The cause for such a high value is unknown. Nonetheless, it is believed that the [higher] intricacy and [higher] mechanical strength of the EM-Balance [PP] as described above are the causes for the higher values.

9. Dielectric Strength Measurement

EM-Balance showed better performance in all electrical properties. EM-Balance was about 1.2 times better than PP particularly in dielectric strength.

10. Melting Point Measurement

EM-Balance PP and normal PP of the same grade were placed in [separate] test tubes and the test tubes were placed in an oil bath to measure melting points.
EM-Balance PP=148.5° C., heating rate 0.5° C./min (alcohol thermometer)
Normal PP=165.0° C., heating rate 0.3° C. (alcohol thermometer)

The test was repeated and measurements were taken each time. The melting point of EM-Balance [PP] was lower than normal PP by 15° C. on average.

### Conclusion

The difference in physical properties between the EMB PP and normal PP was investigated. Based on the data collected, apparent differences in some of the aforementioned physical properties were observed between EM-Balance [PP] and conventional polypropylene.

### Antibacterial Effect Test

Specimen: EM-034 PE film (EMB+Bamboo charcoal powder 0.05%)
Test Summary: The antibacterial effect of the specimen was tested with reference to the test method defined by 5.2 plastic products of JIS Z 2801: 2000 “Antibacterial Coating Product—Antibacterial Test Method and Antibacterial Effects”. The tests were done after the incubation for 6 and 24 hours, and the measurement was taken once.
Test Results: Table 1 illustrates the results; Table 2 illustrates the antibacterial activity value computed by the following formula; and Table 3 illustrates a summary of liquid media used for the test.
   Antibacterial Activity Value=log (B/C)
   B: Viable cell count after 6 and 24 hours on each non-coated sample piece.

C: Viable cell count after 6 and 24 hours on each specimen.

TABLE 19
Results of Viable Cells Counted on Test Samples

| | | | Viable |
|---|---|---|---|
| | | | Cell |
| | | | Counts |
| | | | per |
| Tested Bacteria | Segment | Subject | Sample |
| Escherichia | Immediately after inoculation | Not coated | 3.0 × 10⁵ |
| coli | 35° C. After 6 hours | Specimen | 6.0 × 10⁴ |
| | | Not coated | 2.7 × 10⁶ |
| | 35° C. After 24 hours | Specimen | 5.3 × 10³ |
| | | Not coated | 2.1 × 10⁷ |
| Staphylococcus | Immediately after inoculation | Not coated | 3.5 × 10⁵ |
| aureus | 35° C. After 6 hours | Specimen | 4.7 × 10² |
| | | Not Coated | 1.3 × 10⁵ |
| | 35° C. After 24 hours | Specimen | <10 |
| | | Not Coated | 6.9 × 10⁵ |

<10: None detected.
Escherichia coli IFO 3972
Staphylococcus aureus subsp. aureus IFO 12732

TABLE 20
Antibacterial Activity Value

Antibacterial Activity Value*

| Tested Bacteria | 6 hours later | 24 hours later |
|---|---|---|
| Escherichia coli | 1.6 | 3.6 |
| Staphylococcus aureu | 2.4 | 4.8 |

*Antibacterial effect: Antibacterial activity value ≧2.0

TABLE 21
Summary of Liquid Media Used in the Test

| | | |
|---|---|---|
| Amount of Liquid Medium | Escherichia coli | 0.4 ml |
| Inoculated | Staphylococcus aureu | 0.4 ml |
| Viable Cell Count | Escherichia coli | 7.4 × 10⁵/ml |

### Test and Inspection Report

Apr. 23, 2002
   To: Whitemax, Co., Ltd., Requester

The samples you requested to our laboratory on Apr. 4, 2002 were tested. We hereby certify that the results shown below are true.
Ministry of Health, Labor and Welfare Appointed Testing Organization
   Ministry of Health, Labor and Welfare SeiEi No. 650
Kyoto Microbial Research Laboratory Incorporated Association
   16-2, Kamihanada Kubo-Cho, Yamashina-Ku, Kyoto City
   Tel: 075-593-3320 Fax: 075-501-7110 {Seal Impression}
      Inspection Manager: {seal impression: illegible}
         1. Sample Product Name: EM-042 EM-044 EM-Balance
         2. Test objective: Antibacterial Effect Evaluation Test
         3. Test Method: Film Contact Method

In accordance with the “The Film Contact Method defined by Antibacterial Product Technology Council”, the liquid culture prepared in a 1/500 normal bouillon was dropped on the surface of the sample piece and sealed with a film, followed by incubation at 35° C. A measurement was taken by counting viable cells in the liquid culture on the sample.

4. Strain Used: Staphylococcus aureus IFO-12689

Methicillin resistant Staphylococcus aureus KB-1005 (MRSA)

5. Culture Used: Standard Agar Culture (Eiken)

TABLE 22
Cell Count (Change in Cell Count Over Time)

| | | Microbe Name: Ps. aeruginosa | | | | |
|---|---|---|---|---|---|---|
| Sample | | Initial | 24 hrs-1 | 24 hrs-2 | 24-hrs-3 | Average |
| 1 | EM-042 (HIET) | 3.1 × 10⁵ | 2.6 × 10⁵ | 3.4 × 10⁵ | 3.1 × 10⁵ | 3.0 × 10⁵ |
| 2 | EM-044 (HIET + Bamboo | 3.1 × 10⁵ | 4.4 × 10⁵ | 4.1 × 10⁵ | 4.6 × 10⁵ | 4.4 × 10⁵ |
| | charcoal 0.05%) | | | | | |
| 3 | EM-Balance | 3.1 × 10⁵ | 2.6 × 10⁴ | 1.8 × 10⁴ | 2.3 × 10⁴ | 2.2 × 10⁴ |
| C | Control (Normal) | 3.1 × 10⁵ | 1.7 × 10⁷ | 2.0 × 10⁷ | 2.2 × 10⁷ | 2.0 × 10⁷ |

TABLE 23

| | | Microbe Name: MSRA | | | | |
|---|---|---|---|---|---|---|
| Sample | | Initial | 24 hrs-1 | 24 hrs-2 | 24-hrs-3 | Average |
| 1 | EM-042 (HIET) | 3.5 × 10⁵ | 5.5 × 10⁴ | 4.6 × 10⁴ | 4.7 × 10⁴ | 4.9 × 10⁴ |
| 2 | EM-044 (HIET + Bamboo | 3.5 × 10⁵ | 4.2 × 10⁴ | 4.8 × 10⁴ | 4.5 × 10⁴ | 4.5 × 10⁴ |
| | charcoal 0.05%) | | | | | |
| 3 | EM-Balance | 3.5 × 10⁵ | 1.6 × 10³ | 1.8 × 10³ | 1.9 × 10³ | 1.8 × 10³ |

The L-ascorbic Acid Test was conducted by Shin Nihon Kentei Kyokai (The Non-Profit Organization) on Jul. 6, 1998. The result of the test is as follows.

TABLE 24
L-ascorbic Acid Test Performance

| | |
|---|---|
| Sample | Kiwi Fruit |
| Condition to be Noted | Stored at 10° C. for 7 days |
| Quantity and Number of | 3 samples |
| Sample | |
| Contact Representative | Kishio Moriya |
| and Phone No. for | 06-614-7627 |
| the Test | |

| | | L-ascorbic Acid (mg/100 g) | |
|---|---|---|---|
| | | Polyethylene | EM-Balance |
| Test Results | Days Stored | Bag | Bag |
| | 0 | 66.6 | 66.6 |
| | 7 | 42.9 | 54.4 |

Summary of the Test Method:
Each sample was placed in an EM-Balance bag and a polyethylene bag,
and stored at 10° C. for 7 days. Then, L-ascorbic acid was quantified.
Inspection Method: The high speed liquid chromatography method was
used.
End.

The Sweetness and L-ascorbic Acid Test was conducted by Shin Nihon Kentei Kyokai (The Non-Profit Organization)on Sep. 10, 1998. The result of the test is as follows.

TABLE 25
Sweetness and L-ascorbic Acid Test Performance

| Sample | Petit Tomato |
|---|---|
| Condition to be Noted | Stored at 10° C. for 7 days |
| Quantity and Number of | 3 samples |
| Sample | |
| Contact Representative | Kishio Mariya |
| and Phone No. for the Test | 06-614-7627 |

| | | | L-ascorbic |
|---|---|---|---|
| | Storage | Sweetness | Acid (mg/ |
| Test Results | Condition | (%) | 100 g) |
| | 0 | 6.0 | 73.7 |
| | Day 7 | 7.5 | 67.7 |
| | (Polyethylene Bag) | | |
| | Day 7 | 8.2 | 70.0 |
| | (EM-Balance Bag) | | |

Summary of the Test Method:
Each sample was placed in an EM-Balance bag and a polyethylene bag,
and stored at 10° C. for 7 days. Then, L-ascorbic acid was quantified²⁾.

| | |
|---|---|
| Inspection Method: | 1) A refractive sweet meter; and |
| | 2) the high speed liquid chromatography method |
| | were used. |
| End. | |

What is claimed is:

1. A plastic resin composition, wherein a mixture of a thermoplastic resin includes water for exhibiting physical properties different from those as shown in conventional plastic resin composition.

2. A plastic resin composition for use as a food packaging material, wherein a mixture of a thermoplastic resign includes water for inhibiting the oxidative process which causes food degradation and decay and enhancing the antioxidant strength of the food itself.

3. A plastic resin composition for use as a food packaging material, wherein a mixture of a thermoplastic resign includes water for inhibiting the oxidative process which causes food degradation and decay and enhancing the antioxidant strength of the food itself.

4. A plastic resin composition for use as a water tank, wherein a mixture of a thermoplastic resign includes water for turning tap water into oxygen-rich fresh mild water.

5. A plastic resin composition for use as a plastic film material, wherein a mixture of a thermoplastic resign includes water for exhibiting infrared absorption spectrum different from that of a normal plastic resin composition without water.

6. A plastic resin composition for use as a plastic film material, wherein a mixture of a thermoplastic resign includes water for exhibiting a dielectric strength different from that of a normal plastic resin composition without water.

7. A plastic resin composition for use as a plastic film material, wherein a mixture of a thermoplastic resign includes water for exhibiting a dielectric strength different from that of a normal plastic resin composition without water.

8. A plastic resin composition for use as a plastic film material, wherein a mixture of a thermoplastic resign includes water for exhibiting antibacterial effect different from that of a normal plastic resin composition without water.

9. A plastic resin composition for use as a mattress, futon or other sleeping material, wherein a mixture of a thermoplastic resign includes water for exhibiting change in dermal temperature different from that of a normal plastic resin composition without water.

10. A plastic resin composition for use as a mattress, futon or other sleeping material, wherein a mixture of a thermoplastic resign includes water for exhibiting a lower β/α wave component ratio different from that of a normal plastic resin composition without water, wherein β wave represents the resting, eye closed, and awaken state and α represents the eye-opened, tense and excited state.

11. A plastic resin composition for use as underwear material, wherein a mixture of a thermoplastic resign includes water for exhibiting change in blood state different from that of a normal plastic resin composition without water, wherein red cells aggregated are separated and in the easy-to-flow state.

12. A plastic resin composition for use as a container material, wherein a mixture of a thermoplastic resign includes water for suppressing cancer cell proliferation and survival.
